(19) United States
(12) Patent Application Publication
(10) Pub. No.: US 2026/0307692 A1
(43) Pub. Date: Oct. 8, 2026

(54) SYSTEM AND METHOD FOR IMPROVED RAIL BRIDGE STRIKE DETECTION

(71) Applicant: Southern Methodist University, Dallas, TX (US)

(72) Inventors: Brett Story, Rockwall, TX (US); Hussam Aldeen M Khresat, Dallas, TX (US); Jase D. Sitton, Rockwall, TX (US)

(21) Appl. No.: 19/386,851

(22) Filed: Nov. 12, 2025

Related U.S. Application Data
(60) Provisional application No. 63/782,231, filed on Apr. 2, 2025.

(51) Int. Cl. B61L 23/04; G06N 3/045; G06N 3/0464; G06N 3/084

(52) U.S. Cl. CPC B61L 23/042; G06N 3/045; G06N 3/0464; G06N 3/084

(57) ABSTRACT

A system and computer-implemented method for detecting structure strikes by vehicles includes a first convolution neural network trained with a set of first structure data comprising a first vehicle response data, a first structure strike data and a first synthetic structure strike data, and a second convolution neural network trained with a set of second structure data comprising a second vehicle response data, a second structure strike data and a second synthetic structure strike data. New first and second structure data are fed into the first and second convolution neural networks. A set of features are automatically extracted from the first and second convolution neural networks. The set of features extracted from the first and second convolution neural networks are then concatenated. The concatenated set of features are then classified as a structure strike or a no structure strike using a back propagation network.

### CROSS-REFERENCE TO RELATED APPLICATIONS

This application claims priority to U.S. Provisional Application Ser. No. 63/782,231, filed Apr. 2, 2025, the entire contents of which are incorporated herein by reference.

### STATEMENT OF FEDERALLY FUNDED RESEARCH

This invention was made with government support under Federal Railroad Administration Contract No. 693JJ620C000005 awarded by the U.S. Department of Transportation. The government has certain rights in the invention.

### TECHNICAL FIELD OF THE INVENTION

The present disclosure relates in general to neural networks, and more particularly, to systems and methods for detection of structure strikes by vehicles.

### BACKGROUND OF THE INVENTION

Without limiting the scope of the disclosure, its background is described in connection with rail bridge strike detection.

Railroad bridges serve as critical links in rail infrastructure by providing efficient means of crossing natural and constructed interruptions in terrain. According to the Association of American Railroads (AAR), the total US freight transported in 2020 was 19.3 billion tons and is expected to reach 25.1 billion tons in 2040 (AAR, 2023). Rail bridges support this expansion but face significant challenges including normal wear and tear from aging and typical service, increasing demands, and acute loading events such as natural disasters or strikes from other modes of transport. Low clearance rail bridges are susceptible to strikes from overheight vehicles or equipment exceeding posted bridge clearances. The Transportation Technology Center (TTC) reported that approximately 50% of total rail bridge service interruptions that occurred between 1999 and 2010 in the United States were linked to vehicle collisions with railroad bridges (Joy et al., 2013; Ozdagli et al., 2020). Internationally, Network Rail reported 30,000 rail bridge strikes in the United Kingdom from 2000 to 2017 (Ozdagli et al., 2020; Network Rail, 2017). Depending on strike severity, these incidents can cause damage to bridge sub- and superstructures, putting public safety at risk (Nguyen & Brilakis, 2016). Currently, the US Department of Transportation's (USDoT) Federal Railroad Administration (FRA) mandates bridge inspection after every bridge strike, regardless of strike severity or potential for damage to the bridge (FRA, 2018). Typically detecting vehicle bridge strikes involves analyzing bridge dynamic response. However, both strikes and non-strikes cause bridges to vibrate and differentiating between the two signal types can be challenging due to their sometimes-subtle differences.

Opportunities exist to deploy on-bridge monitoring systems capable of identifying potential bridge strikes for subsequent evaluation. Improved accessibility and scalability of technology has generally increased instances of physical installations of sensors on critical bridge systems (Beck et al., 2001; Yuen & Katafygiotis, 2006). Common instrumentation examples include accelerometers (Guzman-Acevedo et al., 2019; Moreu et al., 2017; Omidalizarandi et al., 2020), inclinometers (Otter et al., 2017; Sitton, Story, et al., 2017a; Vardanega et al., 2022), and strain gages (Kołakowski et al., 2011; Otter et al., 2017; Story & Fry, 2014b). These sensors record measurable quantities of bridge response caused by structural excitation, for example, excitation from a passing train or a vehicle-bridge strike. Specific to bridge strike detection, previous research efforts have used threshold-based approaches to classify strikes versus trains (Byrne, 2009; Fu et al., 2022; Yang, 2015), which lack accuracy. Threshold-based classification systems are susceptible to event misclassification; if the threshold is too high, low severity strikes may be undetected, and if the threshold is too low, the system may confuse a passing train with a strike.

Artificial neural networks (ANNs) afford promising supplemental diagnostic capabilities in structural monitoring and evaluation (Adeli, 2001; Lam et al., 2006; Story & Fry, 2014b). ANNs can be trained to recognize subtle patterns within input data streams and then apply their acquired knowledge to classify future events (Hagan et al., 1996; Haykin, 1994; Rosenblatt, 1958). ANNs are used in a variety of fields including establishing a structural impairment detection framework (Lam et al., 2006; Qiao et al., 2012; Story & Fry, 2014b), creating structural system identification models (Graf et al., 2012; Jiang & Adeli, 2005), and have been used for bridge strike detection to distinguish bridge strikes from passing trains (Lawal et al., 2023; Sitton, Story, et al., 2017a; Sitton et al., 2019). Previous strike detection machine learning applications included creating an ensemble of networks trained on manually identified and calculated features to classify trains versus strikes (Lawal et al., 2023; Sitton et al., 2019). Specifically, ANNs have been trained on manually calculated features to classify impacts vs non-impacts. However, isolating the appropriate part of the signal to calculate features is challenging especially that the available non-strikes and strikes signatures vary significantly in character. Moreover, the complex upfront signal processing required for these techniques is challenging as it is difficult to identify (1) event signatures for training in recorded time histories and (2) the most meaningful features within a data set. Alternatively, convolutional neural networks (CNNs) represent a subclass of ANNs commonly used for image classification that can automatically extract the essential features within the input data and recognize patterns relevant to a specific output. Pertinent to structural healthmonitoring (SHM), CNNs are used to develop structural damage detection systems (Abdeljaber et al., 2017; Avci et al., 2017, 2018) and CNN-based crack damage recognition systems (Cha et al., 2017; Gopalakrishnan et al., 2018; Zhang et al., 2019).

While ANNs are powerful tools to aid the structural monitoring process, system performance is dependent on input data streams, network architecture, and available training data. These parameters need to be carefully considered to create a high-performance model (Israel et al., 2021; Luo et al., 2018; Story & Fry, 2014a). Character, quality, and quantity of input data streams are critical to the performance of CNNs. Additionally, fusing multiple diagnostic heterogeneous data streams may provide improved performance as separate data streams may provide separate diagnostic content (Ge et al., 2018; Tu et al., 2018; Sitton, Zeinali, et al., 2017b).

As a result, there is a need for a system and method for detection of structure strikes by vehicles.

### SUMMARY OF THE INVENTION

The embodiments described herein represent a branched convolutional neural network (CNN) system capable of classifying signals captured on structures, such as low clearance rail bridges, as strikes or non-strikes. This system fuses data streams of different natures, i.e. heterogenous as inputs signals from which it automatically extracts the set of features used for training the network. On average, the systems and methods described herein detect 95% of all strikes with less than 2% false positives rate.

One embodiment of the present disclosure provides a computer-implemented method for detecting structure strikes by vehicles. A first convolution neural network trained with a set of first structure data is provided. The set of first structure data includes a first vehicle response data, a first structure strike data and a first synthetic structure strike data. A second convolution neural network trained with a set of second structure data is provided. The set of second structure data includes a second vehicle response data, a second structure strike data and a second synthetic structure strike data. A new first structure data is fed into the first convolution neural network and a new second structure data is fed into the second convolution neural network. A set of features from the first convolution neural network and the second convolution neural network are automatically extracted by one or more processors. The set of features extracted from the first convolution neural network and the second convolution neural network are concatenated by the one or more processors. The concatenated set of features are classified by the one or more processors as a structure strike or a no structure strike using a back propagation network.

In one aspect, a structure strike severity is determined by one or more processors whenever an output of the back propagation network is the structure strike. In another aspect, the new first structure data is received from one or more first sensors and the new second structure data is received from one or more second sensors in near real time or real time. In another aspect: a message is automatically sent by the one or more processors to one or more devices communicably coupled to the one or more processors whenever an output of the back propagation network is the structure strike; or one or more displays communicably coupled to the one or more processors are automatically updated by the one or more processors to indicate the structure strike whenever the output of the back propagation network is the structure strike. In another aspect, the first structure data and the second structure data comprise heterogenous data streams. In another aspect, the first structure data and the second structure data are sampled at different rates. In another aspect, the first structure data comprises an acceleration data, a tilt data, a time series data, an image data, or an event report data; the second structure data comprises the acceleration data, the tilt data, the time series data, the image data, or the event report data; and the first structure data is not the same as the second bridge data. In another aspect, the first or second convolution neural network is trained by: combining, by the one or more processors, a set of vehicle response data with a set of structure strike data for a set of structures; creating, by the one or more processors, a set of synthetic structure strike data by upsampling the set of structure strike data; for each structure, downsampling, by the one or more processors, the set of vehicle response data for the structure; for each structure, feeding, by the one or more processors, the set of downsampled vehicle response data for the structure, the structure strike data for the structure and the synthetic structure strike data for the structure into a convolution neural network cluster for the structure; generating, by the one or more processors, a set of randomly initialized convolution neural network clusters for each convolution neural network cluster; and training, by the one or more processors, each randomly initialized convolution neural network cluster using a random training subset of the downsampled vehicle response data, the structure strike data and the synthetic structure strike data. In another aspect: upsampling the set of structure strike data is performed until the set of structure strike data plus the set of synthetic structure strike data is approximately the same size as the set of vehicle response data for the set of structure; or downsampling the set of vehicle response data for the structure is performed until the set of downsampled vehicle response data for the structure is approximately equal to the set of structure strike data for the structure plus the set of synthetic structure strike data for the structure. In another aspect, each randomly initialized convolution neural network cluster is validated by the one or more processors using a random validation subset of the downsampled vehicle response data, the structure strike data and the synthetic structure strike data, wherein the random training subset is different the random validation subset. In another aspect, the set of vehicle response data and the set of structure strike data are standardized. In another aspect, the upsampling is performed at a multiplier of one, two, three, four, five or more.

Another embodiment of the present disclosure provides a computerized system for detecting structure strikes by vehicles that includes a first convolution neural network, a second convolution neural network, a back propagation network, and one or more processors. The first convolution neural network is trained with a set of first structure data comprising a first vehicle response data, a first structure strike data and a first synthetic structure strike data. The second convolution neural network is trained with a set of second structure data comprising a second vehicle response data, a second structure strike data and a second synthetic structure strike data. The one or more processors are configured to feed a new first structure data into the first convolution neural network and a new second structure data into the second convolution neural network, automatically extract a set of features from the first convolution neural network and the second convolution neural network, concatenate the set of features extracted from the first convolution neural network and the second convolution neural network, and classify the concatenated set of features as a structure strike or a no structure strike using the back propagation network.

In one aspect, the one or more processors are configured to determine a structure strike severity whenever an output of the back propagation network is the structure strike. In another aspect, the system includes: one or more first sensors communicably coupled to the one or more processors; one or more second sensors communicably coupled to the one or more processors; wherein the one or more processors receive a new first structure data from the one or more first sensors and a new second structure data from the one or more second sensors in near real time or real time. In another aspect, the system includes: one or more devices communicably coupled to the one or more processors, wherein the one or more processors are configured to automatically send a message to the one or more devices whenever an output of the back propagation network is the structure strike; or one or more displays communicably coupled to the one or more processors, wherein the one or more processors are configured to automatically update the one or more displays to indicate the structure strike whenever the output of the back propagation network is the structure strike. In another aspect, the first structure data and the second structure data comprise heterogenous data streams. In another aspect, the first structure data and the second structure data are sampled at different rates. In another aspect: the first structure data comprises an acceleration data, a tilt data, a time series data, an image data, or an event report data; the second structure data comprises the acceleration data, the tilt data, the time series data, the image data, or the event report data; and the first structure data is not the same as the second structure data. In another aspect, the one or more processors train the first or second convolution neural network by: combining a set of vehicle response data with a set of structure strike data for a set of structure; creating a set of synthetic structure strike data by upsampling the set of structure strike data; for each structure, downsampling the set of vehicle response data for the structure; for each structure, feeding the set of downsampled vehicle response data for the structure, the structure strike data for the structure and the synthetic structure strike data for the structure into a convolution neural network cluster for the structure; generating a set of randomly initialized convolution neural network clusters for each convolution neural network cluster; and training each randomly initialized convolution neural network cluster using a random training subset of the downsampled vehicle response data, the structure strike data and the synthetic structure strike data. In another aspect: upsampling the set of structure strike data is performed until the set of structure strike data plus the set of synthetic structure strike data is approximately the same size as the set of vehicle response data for the set of structure; or downsampling the set of vehicle response data for the structure is performed until the set of downsampled vehicle response data for the structure is approximately equal to the set of structure strike data for the structure plus the set of synthetic structure strike data for the structure. In another aspect, the one or more processors validate each randomly initialized convolution neural network cluster using a random validation subset of the downsampled vehicle response data, the structure strike data and the synthetic structure strike data, wherein the random training subset is different the random validation subset. In another aspect, the one or more processors standardize the set of train response data and the set of structure strike data. In another aspect, the upsampling is performed at a multiplier of one, two, three, four, five or more.

Another embodiment of the present disclosure provides a computer-implemented method for detecting bridge strikes. A bridge acceleration convolution neural network trained with a set of bridge acceleration data is provided. The set of bridge acceleration data includes train response acceleration data, bridge strike acceleration data and synthetic bridge strike acceleration data. A bridge tilt convolution neural network trained with a set of bridge tilt data is provided. The set of bridge tilt data includes a train response tilt data, bridge strike tilt data and synthetic bridge strike tilt data. New bridge acceleration data is fed into the bridge acceleration convolution neural network and new bridge tilt data is fed into the bridge tilt convolution neural network. A set of features is automatically extracted, by one or more processors, from the bridge acceleration convolution neural network and the bridge tilt convolution neural network. The set of features extracted from the bridge acceleration convolution neural network and the bridge tilt convolution neural network are concatenated by the one or more processors. The concatenated set of features are classified by the one or more processors as a bridge strike or a no bridge strike using a back propagation network.

In one aspect, a bridge strike severity is determined by one or more processors whenever an output of the back propagation network is the bridge strike. In another aspect, the new first bridge data is received from one or more first sensors and the new second bridge data is received from one or more second sensors in near real time or real time. In another aspect: a message is automatically sent by the one or more processors to one or more devices communicably coupled to the one or more processors whenever an output of the back propagation network is the bridge strike; or the one or more processors automatically update one or more displays communicably coupled to the one or more processors to indicate the bridge strike whenever the output of the back propagation network is the bridge strike. In another aspect, the new bridge acceleration data and the new bridge tilt data are heterogenous data streams. In another aspect: the new bridge acceleration data comprises at least two of a lateral acceleration data, a longitudinal acceleration data and a vertical acceleration data; and the new bridge tilt data comprises at least one of a rotation data about a longitudinal axis and a rotation data about a lateral axis. In another aspect: the bridge acceleration convolution neural network or the bridge tilt convolution neural network are further trained with a set of time series data, a set of image data, or a set of event report data; or a new time series data, new image data, or new event report data is fed into the bridge acceleration convolution neural network or the bridge tilt convolution neural network. In another aspect, the bridge acceleration convolution neural network or the bridge tilt convolution neural network are trained by: combining, by the one or more processors, a set of train response data with a set of bridge strike data for a set of bridges; creating, by the one or more processors, a set of synthetic bridge strike data by upsampling the set of bridge strike data; for each bridge, downsampling, by the one or more processors, the set of train response data for the bridge; for each bridge, feeding, by the one or more processors, the set of downsampled train response data for the bridge, the bridge strike data for the bridge and the synthetic bridge strike data for the bridge into a convolution neural network cluster for the bridge; generating, by the one or more processors, a set of randomly initialized convolution neural network clusters for each convolution neural network cluster; and training, by the one or more processors, each randomly initialized convolution neural network cluster using a random training subset of the downsampled train response data, the bridge strike data and the synthetic bridge strike data. In another aspect: upsampling the set of bridge strike data is performed until the set of bridge strike data plus the set of synthetic bridge strike data is approximately the same size as the set of train response data for the set of bridges; or downsampling the set of train response data for the bridge is performed until the set of downsampled train response data for the bridge is approximately equal to the set of bridge strike data for the bridge plus the set of synthetic bridge strike data for the bridge. In another aspect, each randomly initialized convolution neural network cluster is validated by the one or more processors using a random validation subset of the downsampled train response data, the bridge strike data and the synthetic bridge strike data, wherein the random training subset is different the random validation subset. In another aspect, the set of train response data and the set of bridge strike data are standardized. In another aspect, the upsampling is performed at a multiplier of one, two, three, four, five or more.

Another embodiment of the present disclosure provides a computerized system for detecting bridge strikes that includes a bridge acceleration convolution neural network, a bridge tilt convolution neural network, a back propagation network, and one or more processors. The bridge acceleration convolution neural network is trained with a set of bridge acceleration data comprising train response acceleration data, bridge strike acceleration data and synthetic bridge strike acceleration data. The bridge tilt convolution neural network is trained with a set of bridge tilt data comprising a train response tilt data, bridge strike tilt data and synthetic bridge strike tilt data. The one or more processors are configured to feed new bridge acceleration data into the bridge acceleration convolution neural network and new bridge tilt data into the bridge tilt convolution neural network, automatically extract a set of features from the bridge acceleration convolution neural network and the bridge tilt convolution neural network, concatenate the set of features extracted from the bridge acceleration convolution neural network and the bridge tilt convolution neural network, and classify the concatenated set of features as a bridge strike or a no bridge strike using the back propagation network.

In one aspect, the one or more processors are configured to determine a bridge strike severity whenever an output of the back propagation network is a bridge strike. In another aspect, the system includes: one or more first sensors communicably coupled to the one or more processors; one or more second sensors communicably coupled to the one or more processors; wherein the one or more processors receive a new first bridge data from the one or more first sensors and the a new second bridge data from the one or more second sensors in near real time or real time. In another aspect, the system includes: one or more devices communicably coupled to the one or more processors, wherein the one or more processors are configured to automatically send a message to the one or more devices whenever an output of the back propagation network is the bridge strike; or one or more displays communicably coupled to the one or more processors, wherein the one or more processors are configured to automatically update the one or more displays to indicate the bridge strike whenever the output of the back propagation network is the bridge strike. In another aspect, the new bridge acceleration data and the new bridge tilt data are heterogenous data streams. In another aspect: the new bridge acceleration data comprises at least two of a lateral acceleration data, a longitudinal acceleration data and a vertical acceleration data; and the new bridge tilt data comprises at least one of a rotation data about a longitudinal axis and a rotation data about a lateral axis. In another aspect, the bridge acceleration convolution neural network or the bridge tilt convolution neural network are further trained with a set of time series data, a set of image data, or a set of event report data; or a new time series data, new image data, or new event report data is fed into the bridge acceleration convolution neural network or the bridge tilt convolution neural network. In another aspect, the bridge acceleration convolution neural network or the bridge tilt convolution neural network are trained by: combining, by the one or more processors, a set of train response data with a set of bridge strike data for a set of bridges; creating, by the one or more processors, a set of synthetic bridge strike data by upsampling the set of bridge strike data; for each bridge, downsampling, by the one or more processors, the set of train response data for the bridge; for each bridge, feeding, by the one or more processors, the set of downsampled train response data for the bridge, the bridge strike data for the bridge and the synthetic bridge strike data for the bridge into a convolution neural network cluster for the bridge; generating, by the one or more processors, a set of randomly initialized convolution neural network clusters for each convolution neural network cluster; and training, by the one or more processors, each randomly initialized convolution neural network cluster using a random training subset of the downsampled train response data, the bridge strike data and the synthetic bridge strike data. In another aspect: upsampling the set of bridge strike data is performed until the set of bridge strike data plus the set of synthetic bridge strike data is approximately the same size as the set of train response data for the set of bridges; or downsampling the set of train response data for the bridge is performed until the set of downsampled train response data for the bridge is approximately equal to the set of bridge strike data for the bridge plus the set of synthetic bridge strike data for the bridge. In another aspect, each randomly initialized convolution neural network cluster is validated by the one or more processors using a random validation subset of the downsampled train response data, the bridge strike data and the synthetic bridge strike data, wherein the random training subset is different the random validation subset. In another aspect, further comprising standardizing the set of train response data and the set of bridge strike data. In another aspect, the upsampling is performed at a multiplier of one, two, three, four, five or more.

As embodied and broadly described herein, the foregoing methods and systems can be implemented as one or more non-transitory computer-readable media that stores instructions that when executed cause a computing device or system to perform the stated operations.

### BRIEF DESCRIPTION OF THE DRAWINGS

For a more complete understanding of the features and advantages of the present invention, reference is now made to the detailed description of the disclosure along with the accompanying figures, in which:

FIG. 1 shows sensor orientation and layout on a sample bridge according to the prior art.

FIG. 2 shows a schematic representation of parallel heterogeneous data-fusion convolutional neural networks (PHD-CNN) data flow according to an implementation of the disclosure.

FIG. 3 shows a branched CNN architecture overview according to an implementation of the disclosure.

FIG. 4 shows a bridge-specific data set makeup to an implementation of the disclosure.

FIGS. 5A-5D show sample acceleration time histories according to an implementation of the disclosure: FIG. 5A typical train, FIG. 5B short, fast moving train, FIG. 5C distinct strike, and FIG. 5D scraping strike.

FIG. 6 is Table 3 showing convolutional neural networks (CNN) architecture ordered top to bottom according to an implementation of the disclosure.

FIGS. 7A-7B show performance results for all data streams on Bridge 1 according to an implementation of the disclosure: (FIG. 7A) strike performance, and (FIG. 7B) false positives rate.

FIGS. 8A-8B show performance results for all data streams on Bridge 2 according to an implementation of the disclosure: (FIG. 8A) strike performance, and (FIG. 8B) false positives.

FIGS. 9A-9B show performance results for all data streams on Bridge 3 according to an implementation of the disclosure: (FIG. 9A) strike performance, and (FIG. 9B) false positives rate.

FIGS. 10A-10B show performance results for all data streams on Bridge 4 according to an implementation of the disclosure: (FIG. 10A) strike performance, and (FIG. 10B) false positives rate.

FIGS. 11A-11B show average performance of combination 10, Bridge 1 according to an implementation of the disclosure: (FIG. 11A) strike performance, and (FIG. 11B) false positives rate.

FIG. 12 is Table 5 showing convolutional neural networks (CNN) architectures with varying width according to an implementation of the disclosure.

FIG. 13 is Table 6 showing convolutional neural networks (CNN) architectures with reduced depth according to an implementation of the disclosure.

FIGS. 14A-14B show average performance combination 10, Bridge 2 according to an implementation of the disclosure: (FIG. 14A) strike performance, and (FIG. 14B) false positives rate.

FIGS. 15A-15B show average performance combination 10, Bridge 3 according to an implementation of the disclosure: (FIG. 15A) strike performance, and (FIG. 15A) false positives rate.

FIGS. 16A-16B show average performance combination 10, Bridge 4 according to an implementation of the disclosure: (FIG. 16A) strike performance, and (FIG. 16A) false positives rate.

FIG. 17 shows the computational time required to train each architecture across all bridges according to an implementation of the disclosure.

FIG. 18 shows a flow chart of a method in accordance with one embodiment of the disclosure.

FIG. 19 shows a block diagram of a system in accordance with one embodiment of the disclosure.

FIG. 20 shows a flow chart of a method in accordance with another embodiment of the disclosure.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

As will be described in more detail below, heterogeneous data streams are fused together though a parallel heterogeneous data-fusion convolutional neural network (PHD-CNN). Specifically, the model fuses field data collected from accelerometers and inclinometers to create the final classification output: either a passing vehicle (e.g., train, etc.) or a structure (e.g., bridge, etc.) strike. Additionally, the following description details, quantifies, and contextualizes the effects of variations in CNN architecture, training data quantity, and input data streams on PHD-CNN performance. Although the description relates to rail bridges equipped with acceleration and/or tilt sensors, the present disclosure is applicable to strikes on other types of structures by other types of vehicles using other types of data.

Real-world data were collected from several in-service rail bridges servicing both freight and passenger train traffic. The bridges used were selected due to their low clearances (10-12 ft) and, therefore, relatively high likelihoods of vehicle-bridge strike scenarios. Data was collected semicontinuously for 6 years in widely varying environmental conditions. Table 1 presents the structural information for the four steel bridges studied; all four bridges are through plate girder bridges with supporting stringer beams and bracing underneath the bridge deck.

TABLE 1
Structural Makeup of Bridges

| | | Deck | | |
|---|---|---|---|---|
| | | Skewness | | |
| Bridge | Type | (Y/N) | Dimensions | Deck |
| 1 | Steel Girder | Y | L: 86 ft | Ballast |
| | | | W: 31 ft | |
| 2 | Steel Girder | Y | L: 55 ft | Open |
| | | | W: 53 ft | |
| 3 | Steel Girder | Y | L: 73 ft | Open |
| | | | W: 51 ft | |
| 4 | Steel Girder | N | L: 76 ft | Open |
| | | | W: 53 ft | |

The total number of available train and strike signatures used in this study are 17,604 and 177, respectively. Strikes represent ~1% of the available training data.

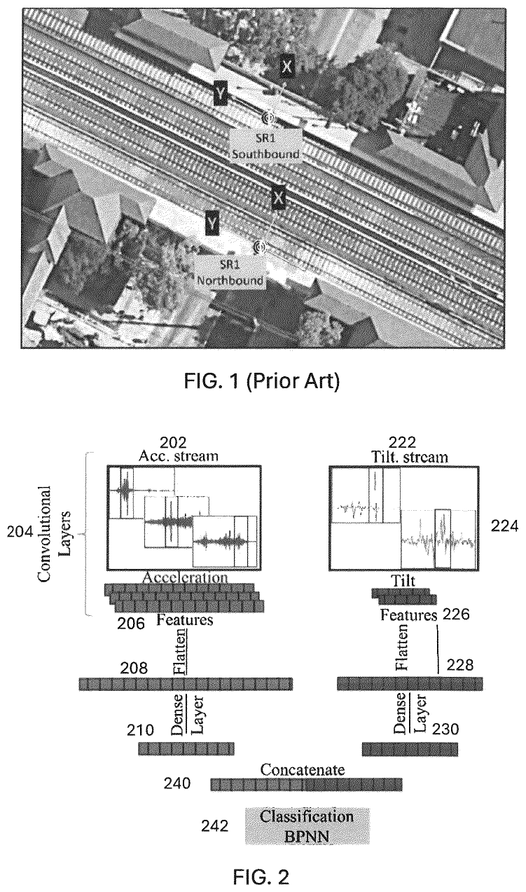

Each bridge was instrumented with two SENSR SR1 sensors: one on each midspan on the inside web of the outermost girder as shown in FIG. 1. Each SR1 records acceleration (g) in three directions: lateral (AccX), longitudinal (AccY), and vertical (AccZ). The SR1 also captures rotation about the Y axis (RotY) and X axis (RotX). Both acceleration and tilt are recorded in 60-s intervals; acceleration is sampled at 100 Hz (6000 samples per signal) and tilt is sampled at 10 Hz (600 samples per signal). Train and strike signals vary in duration within and sometimes across multiple 60-s data windows. Generally, freight train signals are longer than passenger train signals. Strike signals also vary in signal length from very short impulse strikes to repeated, continuous vibration scrapes. Each sensor triggers independently once acceleration or tilt magnitudes exceed specified threshold quantities. Typical threshold quantities for event detection include maximum acceleration (e.g., 0.03-0.08 g) or maximum rotation (0.18-0.32 deg.).

A typical CNN architecture includes convolutional layers, which contain kernels or filters comprising trainable weights that are responsible for automatically extracting features from the input data; pooling layers follow convolutional layers and are responsible for reducing the output size of the preceding layer; and dense layers, which are typically fully connected back propagation neural networks (BPNNs) and are responsible for making the final classification (Kiranyaz et al., 2016; Krizhevsky et al., 2012; LeCun et al., 1998). The number of trainable parameters in the CNN is dependent on the number of layers, layer types, and the number of filters (for convolutional layers) or neurons (for dense layers) in each layer. These parameters represent the weights that are learned and adjusted through the training process of the network (LeCun et al., 1998). In a typical CNN model, all input data streams have the same input size. However, if multiple heterogeneous data streams are to be evaluated, each stream may have different input sizes (e.g., sensors can be sampled at different rates) and the framework must accommodate these dimensional variations.

A PHD-CNN architecture is described herein in which each homogeneous data stream subset of the entire heterogeneous data set (i.e., from the same sensor type and sampled at the same rate) is first processed through an independent, parallel branch of convolution layers. In each branch, the convolution layers are responsible for extracting features from a unique type of input data; for the non-limiting example described herein, the heterogeneous data streams are acceleration and tilt.

The heterogeneous data streams used to train the invention are recorded using accelerometers and tiltmeters that are instrumented on the bridges to be monitored. Once bridge vibrations exceed a certain threshold, due to a strike or non-strike, the sensors are triggered recording the response signals of the bridge. Acceleration is recorded about X, Y, and Z axes while tilt is captured about the lateral and longitudinal axes. Acceleration and tilt signals are sampled at different rates. A typical CNN can only accept input signals of the same size; however the unique branched architecture of the invention allows data streams sampled at different rates to be fed as input through their own exclusive branch. The network automatically extracts its training features from the recorded acceleration and tilt signatures.

The extracted features from each branch are then merged by concatenation and input into a back propagation network (BPNN) for final classification. The extraction of features from both branches simultaneously represents an application of parallel data processing. Parallel data algorithms are common within the field of structural engineering; specifically, computational models that implement parallel data processing have been used for structural optimization tasks (Adeli & Kumar, 1995; Park & Adeli, 1997). FIG. 2 presents an overview of a PHD-CNN and marks the different stages in the network according to an implementation of the disclosure. The parallel data processing nature of the PHD-CNN's framework offers the flexibility of feeding multiple diagnostic data streams into the network regardless of data characteristics (e.g., multichannel time histories of different sample rates, images).

More specifically, an acceleration data stream 202 is fed into a set of convolutional layers 204, which generate acceleration features 206. The acceleration features 206 are flattened 208 and fed into a dense layer 210. Similarly, a tilt data stream 222 is fed into a set of convolutional layers 224, which generate tilt features 226. The tilt features 226 are flattened 228 and fed into a dense layer 230. The output of the dense layer 210 and the output of the dense layer 230 are concatenated 240 and fed into a back propagation network (BPNN) 242 to be classified as a bridge strike or a no bridge strike.

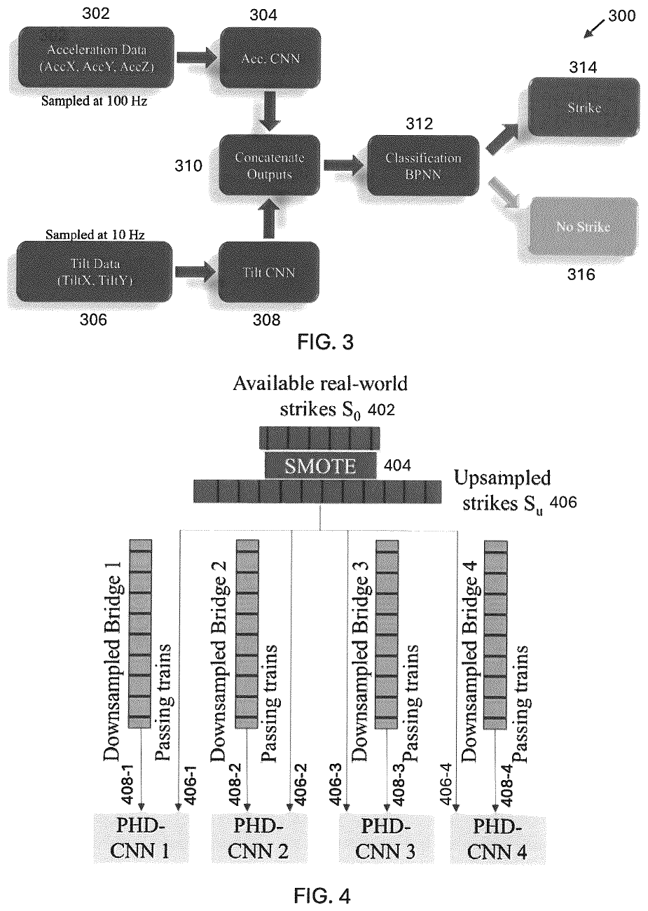

Now referring to FIG. 3, an overview of the branched CNN architecture 300 according to an implementation of the disclosure is shown. Bridge acceleration data 302 (e.g., lateral acceleration data (AccX), longitudinal acceleration data (AccY), vertical acceleration data (AccZ) sampled at 100 Hz) is fed into a trained bridge acceleration convolution neural network 304 (Acc. CNN) while corresponding bridge tilt data 306 (e.g., rotation data about a lateral axis (TiltX), rotation data about a longitudinal axis (TiltY) sampled at 10 Hz) is fed into a trained bridge tilt convolution neural network 308 (Tilt CNN). A set of output or features are extracted from the Acc. CNN 304 and Tilt CNN 308, and then concatenated 310. The concatenated outputs 310 are fed into a classification back propagation network 312 (BPNN), which classifies the data as a strike 314 or a no strike 316.

During the iterative training process the extracted features are refined to minimize the error between the predicted network classification and the true classification. The branched nature of the CNN presented in this disclosure allows for the training of strike detection systems on data types beyond what was used in the non-limiting examples described herein including time series data, image data, event reports, or other types of information. The ability of using heterogenous data streams allows the network to extract useful features from a wider range of input data which have consistently shown that it improves performance.

The system is comprised of 10 network clusters. Each cluster is composed of 10 randomly initialized networks that are trained on a subset of the data input. Ultimately the final signal classification produced by the system represents the average of all 100 networks. The selection of the training subset is random so network clusters may or may not be trained on the same subsets. Thus, the features extracted to train each network may or may not be the same features used to train other networks. Post training each network is validated using a validation subset different than the training subset but may or may not be similar to the subset used to validate other networks. Performance criteria such as network performance and false positives rate are used to evaluate the training process; strike performance measures how accurate is the system at identifying strike signatures and false positives rate which measures how prone was the system to misclassifying a non-impact signature as an impact signature. Also, variance in performance across 100 networks is also computed to determine repeatability of results.

The number of available strike signals is much lower than non-strike signals creating a highly imbalanced training dataset. Specifically, the total number of non-strikes and strikes are 17,604 and 177 signals respectively. Non-strike signals were captured from 4 in-service rail bridges while the strike signatures were recorded across a wide range of bridges. To eliminate bias each network is trained on a subset of non-strikes, 855 signals, and then strike signals are synthetically upsampled using SMOTE algorithm to match the number of non-strikes subset size. Ultimately every network developed was trained and tested on a subset of bridge specific non-strikes signals and on all available strikes in addition to their synthetic equivalents due to scarcity of strikes data. To avoid overfitting every strike signal and its synthetic equivalents can either appear only in the training dataset or only in the validation dataset. Standard scaling is also applied to all signals; this technique is known to improve network performance (Hanker et al., 1996). Table 8 presents the average performance results across all bridges using the branched CNN architecture.

The data preparation process will now be described in more detail. For each bridge, a training data set containing bridge specific train response data and lumped strike data was compiled; the same lumped strike data set is used for each of the four bridges studied. The number of available train signatures greatly exceeds the number of available strike signatures as passing trains occur regularly. This imbalance promotes bias in the training and may ultimately create a model that is heavily weighted toward the majority class and is prone to false positives (Shaikhina & Khovanova, 2017). To mitigate the effects of this imbalance, all available labeled strike signatures (from the four bridges used in the study and six previously monitored bridges) were combined into a single strike data set.

The Synthetic Minority Oversampling Technique (SMOTE) was used to upsample available strikes. The SMOTE algorithm calculates a feature vector for each real minority sample and uses a k nearest neighbors (kNN) approach to create additional synthetic minority class samples (Chawla et al., 2002; Shaikhina, & Khovanova, 2017). The final, balanced data set used for training and testing the model contains real-world train signatures, real-world strike signatures, and synthetic strike signatures. To avoid any statistical bias in model performance, any real-world strike signature and its synthetic equivalents can appear either both in the training data set or both in the testing data set but not distributed among both subsets. Specifically, strike signatures used for model training were synthetically upsampled separately from the synthetic upsampling of the strikes used for testing the model. After training and testing strikes were upsampled to the desired final number of strike events using SMOTE, bridge-specific train signatures were randomly downsampled to match the number of strikes.

Referring now to FIG. 4, the makeup of each bridge-specific data set according to an implementation of the disclosure is shown. As previously described, the available real-world strikes 402 (S₀) are upsampled to create synthetic strikes using the SMOTE algorithm 404. The upsampled strikes 406 (Su) for each bridge (e.g., 406-1, 406-2, 406-3, 406-4) are fed into bridge specific PHD-CNNs (e.g., PHD-CNN 1, PHD-CNN 2, PHD-CNN 3, PHD-CCN 4). The train responses for each bridge are downsampled (e.g., 408-1, 408-2, 408-3, 408-4) and fed into the bridge specific PHD-CNNs (e.g., PHD-CNN 1, PHD-CNN 2, PHD-CNN 3, PHD-CCN 4).

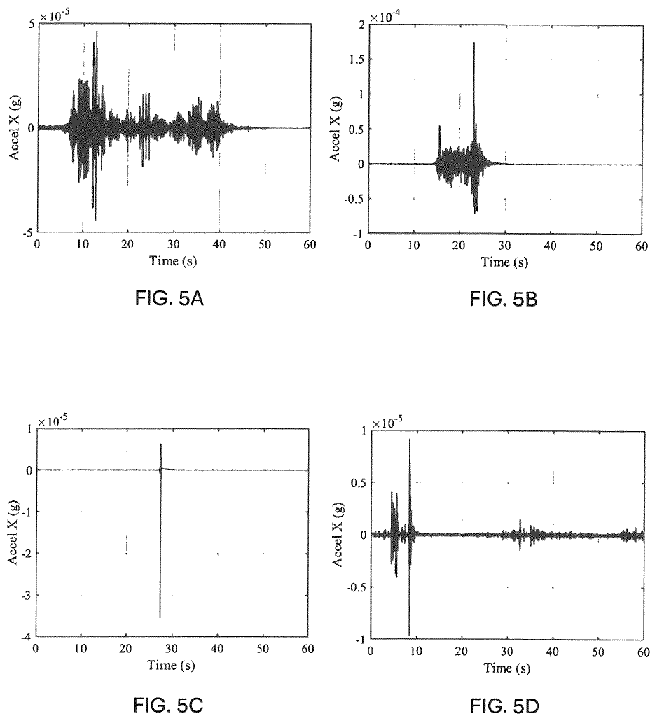

Generally, strike signatures share common features that distinguish them from train signatures; these features can include shorter response length and a single distinct acceleration spike followed by a damped response (Sitton, Story, et al., 2017a; Sitton et al., 2019); however, the diverse nature and severity of bridge strikes blur the differentiating markers between strikes and trains. Recorded strikes used herein vary in severity and character ranging from longer duration minor scrapes to shorter duration high speed impacts. FIGS. 5A-5D illustrate several events represented in the data collected in this research according to an implementation of the disclosure. Comparing the example typical train and light strike in FIGS. 5A and 5C illustrate that typical trains can have acceleration magnitudes higher than light bridge strikes. Comparing FIGS. 5A, 5B, and 5D illustrates the difficulty in relying on signal length to distinguish short, fast moving trains from some bridge strikes. Lastly, FIG. 5D represents a repeated impact/scrape signal with characteristics similar to both passing trains and ideal strikes. In light of these challenges, threshold-based approaches are ineffective for distinguishing bridge strikes from passing trains; however, thresholds are efficient and effective at identifying an event to be evaluated (Lawal et al., 2023).

The effect of data stream combination on CNN performance will now be described. CNN performance is heavily dependent on the input data streams used (Ge et al., 2018; Teng et al., 2022; Tu et al., 2018). In general practice, an optimal diagnostic data stream combination maximizes true positives while minimizing false positives. The data stream combinations investigated are presented in Table 2 and comprise two groups: (1) homogeneous input data comprising only acceleration (i.e., 1-5) or only tilt data streams (i.e., 6-8) and (2) multichannel, heterogeneous input data comprising combinations of acceleration and/or tilt data streams (i.e., 8-10).

TABLE 2
Data Stream Combinations

| Combination | Data Stream(s) |
|---|---|
| 1 | AccX (lateral) |
| 2 | AccY (longitudinal) |
| 3 | AccZ (vertical) |
| 4 | AccX, AccZ |
| 5 | AccX, AccY, AccZ |
| 6 | RotY (about longitudinal axis) |
| 7 | RotX (about lateral axis) |
| 8 | RotY, RotX |
| 9 | AccX, AccX, RotY |
| 10 | AccX, AccY, AccZ, RotY, RotX |

Acceleration and rotations most physically aligned with either strikes (i.e., AccX, RotY) and trains (AccZ) were emphasized.

Each individual data stream is a one-dimensional (1D) vector; thus, 1D convolution layers are used in CNN model. A model trained on only acceleration or only tilt data streams, such as in Combinations 1-8, does not require homogenization using PHD-CNN. The PHD-CNN network architecture was implemented for combinations 9 and 10. To ensure that only the effect of data stream character on performance is isolated, the network architectures for homogeneous and heterogeneous data streams were designed to yield approximately the same number of trainable parameters.

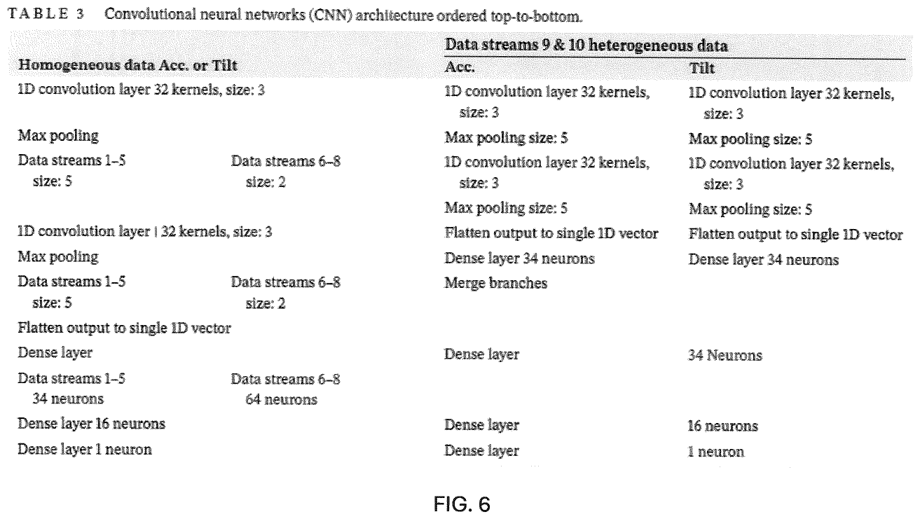

The CNN architectures used for this initial investigation are given in Table 3 (FIG. 6). L2 regularization and dropout with a rate of 0.5 were used to avoid overfitting; these techniques prevent the model from learning irrelevant features and becoming too complex, which improves the model's performance when tested on new data (Ying, 2019). Rectified linear unit (ReLU) activation was used for all internal layers as it protects the network from the vanishing gradient, and sigmoid activation was used for the output layer to produce a binary classification output: 0 for a train or 1 for a strike (Hao et al., 2020).

Standard scaling was applied to the trains and strikes being investigated. Standardization is a common approach in machine learning to improve network performance; it balances the importance of the feature content within the data (Shanker et al., 1996). Data sets were standardized by subtracting the mean of the data set from each signal and dividing the result by the standard deviation of the same data set (Shanker et al., 1996). Two primary evaluation metrics were used to evaluate network performance: Strike performance, or true positives rate (i.e., SP or TPR), and false positives rate (FPR). SP measures how successful a system is at identifying strike signatures and FPR measures how prone a system is to misclassifying train signatures as strike signatures.

Tenfold cross validation was implemented for each bridge and corresponding data stream combination. In 10-fold cross validation, the data set is split into 10 subsets or folds; 10 networks are then trained, each using a different fold as the test data set for that network and the remaining nine folds as the training data set (Berrar, 2018; Geus et al., 2020). Cross validation allows each data sample to be part of the training and the validation data sets across the 10 folds, which helps in better overall model evaluation due to continuous training and testing on unseen data (Nti et al., 2021).

For each network, the strike upsampling occurs after the training and testing folds were established; strikes in the training folds were upsampled separately from the strikes in the testing fold to avoid having a real strike and its synthetic equivalent appear in both the training and testing data. Ultimately, 354 strikes and 354 bridge-specific train signatures comprised the training and testing subsets for the data combination study.

The cross-validation process was repeated 10 times for each evaluation (i.e., 100 total trained networks per data stream combination) to assess the repeatability of performance results for each bridge. The SP and FPR results presented are averages across all 100 networks for each data stream combination for each bridge. Table 4 presents a summary of performance results from this investigation and the highest performance results are emphasized.

TABLE 4
Data Stream Investigation Results Summary

| Average Across All Bridges | |
|---|---|
| Performance | Variance |

| Combinations | SP (%) | FPR (%) | SP | FPR |
|---|---|---|---|---|
| Single 1, 2, 3, 6, 7 | 83.73 | 11.35 | 20.46 | 18.23 |
| Homogeneous 4, 5, 8 | 89.80 | 4.90 | 24.93 | 5.39 |
| Heterogeneous 9, 10 | 91.03 | 2.79 | 6.35 | 0.66 |

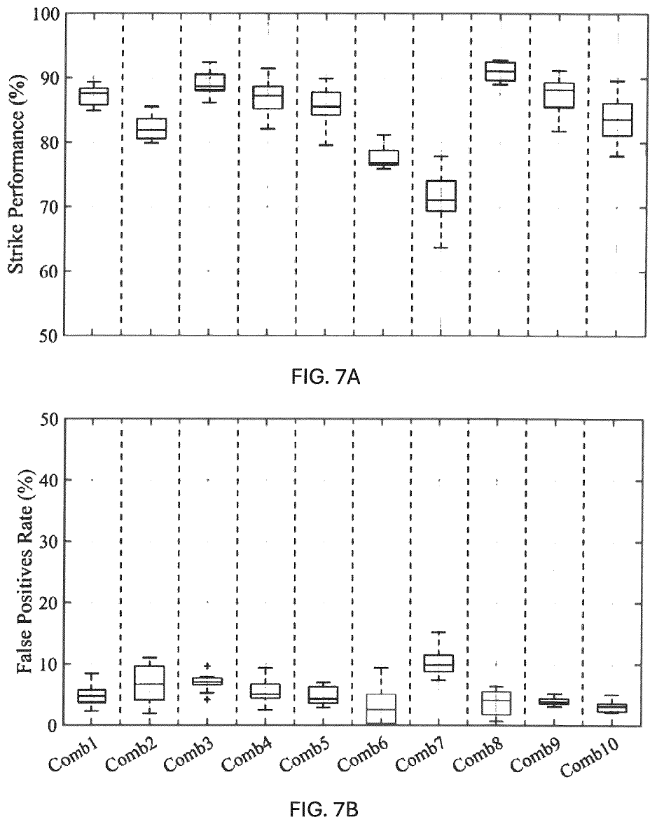

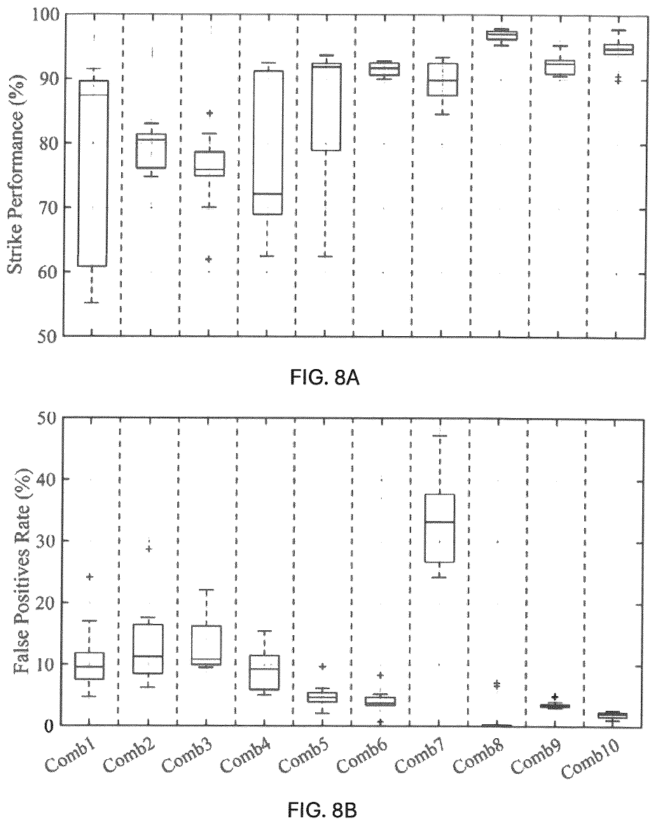

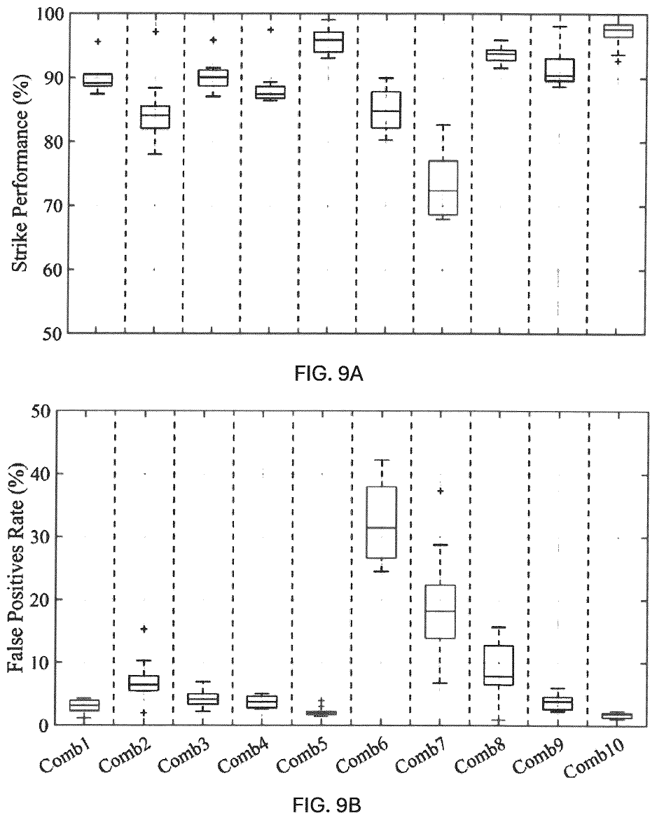

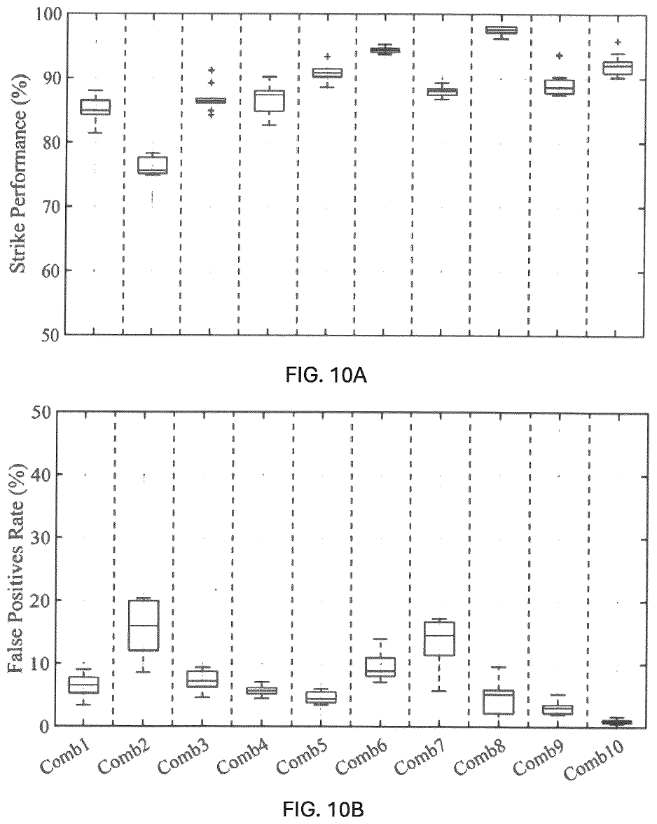

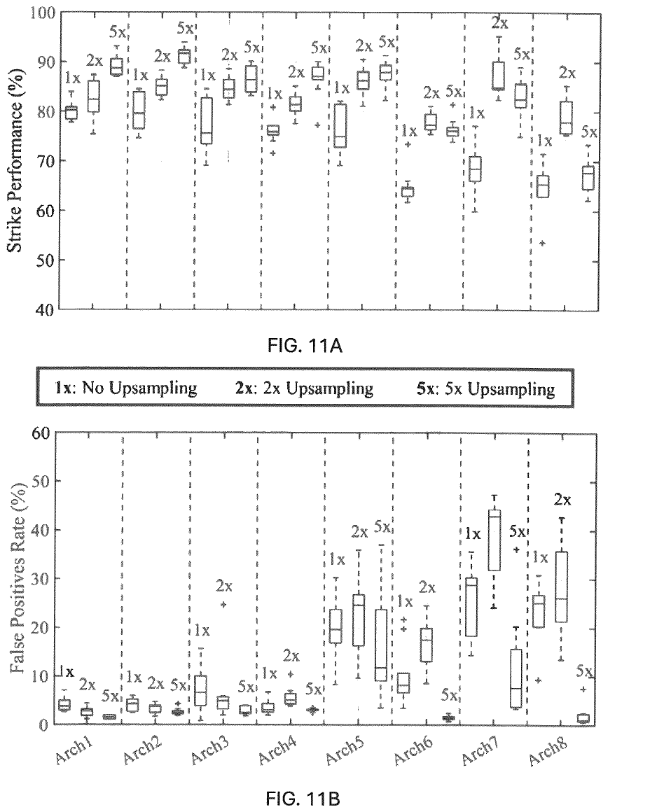

Bridge-specific results are presented in a box plot format to demonstrate the distribution of results across the 100 networks in FIGS. 7A-11B according to an implementation of the disclosure. More specifically, (1) FIGS. 7A-7B show performance results for all data streams on Bridge 1 according to an implementation of the disclosure: (FIG. 7A) strike performance, and (FIG. 7B) false positives rate; (2) FIGS. 8A-8B show performance results for all data streams on Bridge 2 according to an implementation of the disclosure: (FIG. 8A) strike performance, and (FIG. 8B) false positives; (3) FIGS. 9A-9B show performance results for all data streams on Bridge 3 according to an implementation of the disclosure: (FIG. 9A) strike performance, and (FIG. 9B) false positives rate; (4) FIGS. 10A-10B show performance results for all data streams on Bridge 4 according to an implementation of the disclosure: (FIG. 10A) strike performance, and (FIG. 10B) false positives rate; and (5) FIGS. 11A-11B show average performance of combination 10, Bridge 1 according to an implementation of the disclosure: (FIG. 11A) strike performance, and (FIG. 11B) false positives rate.

Across all data stream combinations investigated, single channel, homogeneous input performed the poorest across all bridges. Additionally, networks trained on these data streams experience higher variance indicating less repeatable results. Combining homogeneous data streams improved classification model performance and reduced variability in FPR. Compared to single-channel input models, Combinations 4, 5, and 8 achieved on average across all bridges 6% higher SP and 6.45% lower FPR.

Fusing heterogeneous data streams, specifically data stream combination 10, consistently achieved the highest performance across all bridges as it allows the model to extract useful information from a wider range of features. Combinations 9 and 10, on average across all bridges, achieved 91.03% SP and significantly reduced FPR to 2.79%. Heterogeneous data streams experience significantly more stability in performance yielding repeatable results.

In terms of single acceleration data streams, combination 2 (i.e., longitudinal acceleration) performed worse than all other acceleration data streams. This trend matches physical intuition as the bridges in this study are likely to vibrate most prominently vertically due to a passing train and vibrate laterally due to a strike. Thus, longitudinal information from combination 2 only is an ineffective feature for strike detection. It is also concluded based on the findings of this investigation that CNNs are capable of also identifying and disregarding noise or irrelevant features. For example, the performance of combination 5, which includes combination 2, was not significantly affected by the physically less relevant longitudinal acceleration and performed at least similar to combination 4, which includes lateral and vertical only. Generally, bridges 1-4 experienced similar patterns in performance; however, bridge 1 results were slightly inferior to the other three bridges. An investigation into bridge 1 data revealed that construction activities took place at the bridge, which might indicate the possibility of including recorded construction data as mislabeled train signatures.

The effect of network architecture complexity and data quantity on CNN performance will now be described. In addition to data stream combinations, network architecture and training data set size also influence CNN performance. Networks with higher numbers of trainable parameters require more data during training to reduce the effects of overfitting (Götz et al., 2022). Network performance was investigated for PHD-CNN architectures of varying complexity. Variations in the width and depth of the baseline PHD-CNN architecture used in the data stream combination investigation were investigated. The use of data stream combination 10 yielded the highest performance in the initial data stream investigation presented herein and was selected for this subsequent analysis.

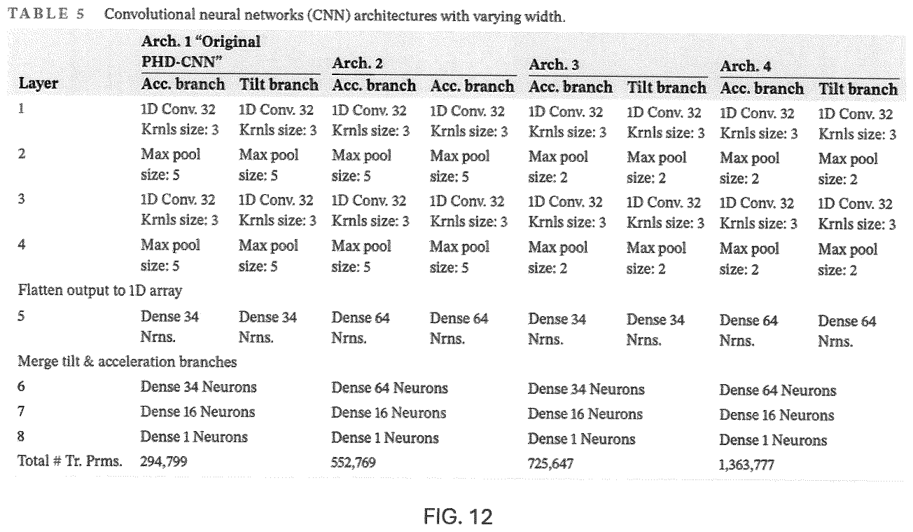

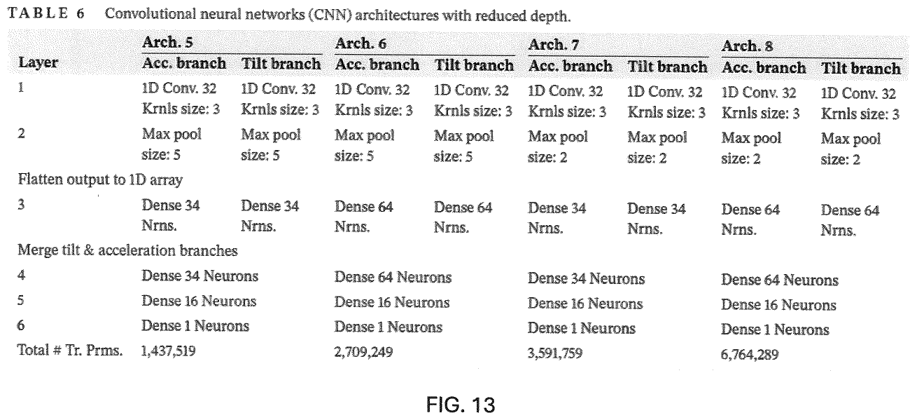

Table 5 (FIG. 12) shows a list of network architectures similar to the original network architecture but with varying max pooling sizes and number of neurons; the baseline PHD-CNN architecture is Arch. 1. Table 6 (FIG. 13) shows the same architectures in Table 5 with reduced depth through the omission of a convolution layer and max pooling operation. The omission of the max pooling layer from deeper networks increases the size of the input signal prior to flattening producing greater number of trainable parameters. As with the original architecture, L2 regularization and a dropout rate of 0.5 were used to avoid overfitting. Dropout was used before each max pooling layer and after each dense layer apart from the final output layer.

All architectures were analyzed with three different data set sizes shown in Table 7.

TABLE 7
Data Set Sizes

| | No. Train | No. Strike |
|---|---|---|
| Data Set | Signatures | Signatures |
| No upsampling | 177 | 177 |
| 2X upsampling | 354 | 354 |
| 5X upsampling | 855 | 855 |

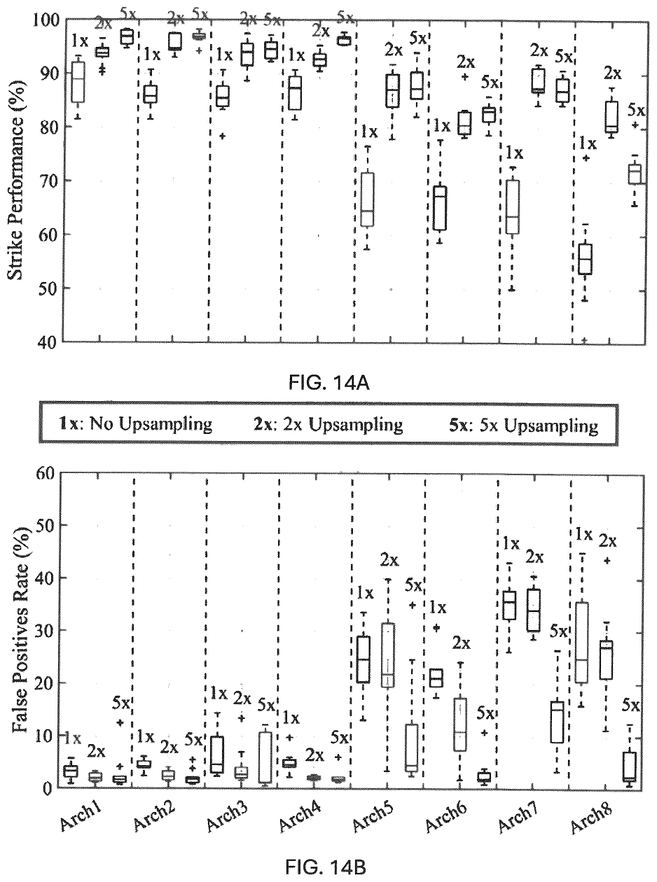

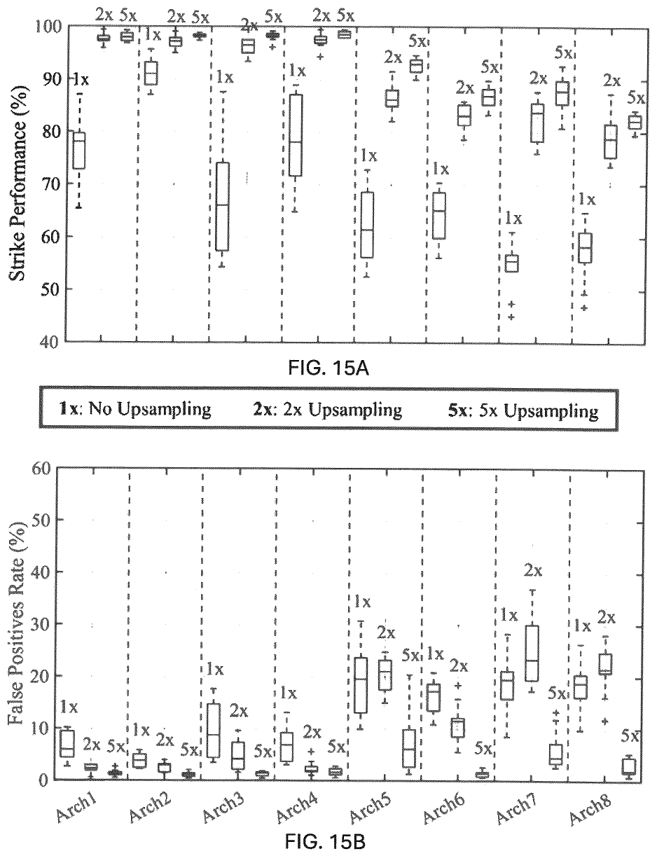

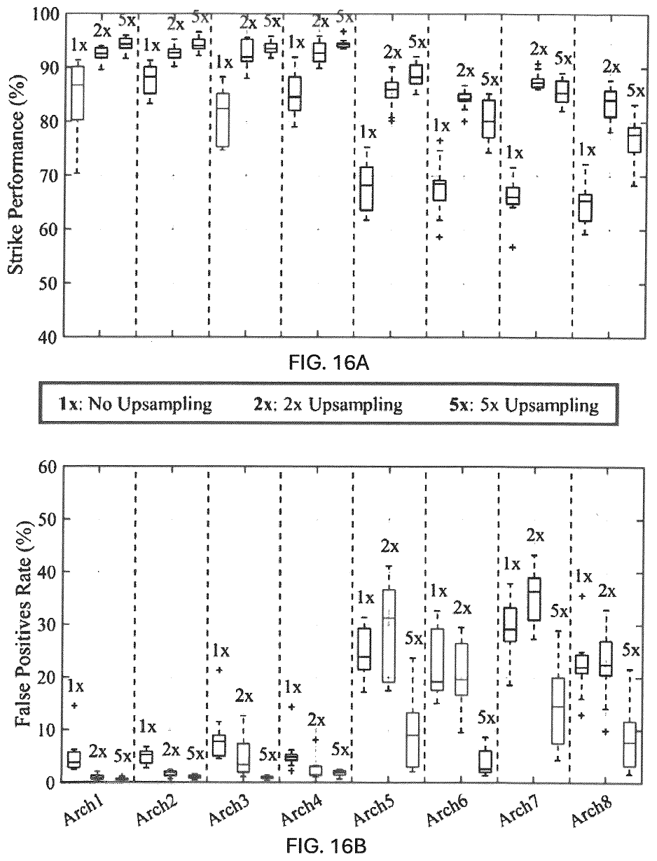

FIGS. 14A-17B compare CNN performance for each of the four bridges in the study with the network architectures and amount of input data shown in Tables 5-7. Table 8 compares performance results for each data set size across all bridges and architectures.

TABLE 8
Average Performance Results for Each Data Set Size Across
All Bridges for the Best Performing Architectures

| | Best Performance Across All Bridges | | | |
|---|---|---|---|---|
| | Average Performance | | | |
| | Strike | False | | |
| | Performance | Positives Rate | Variance | |
| Data Set Size | (SP %) | (FPR %) | SP | FPR |
| No upsampling | 86.10 | 4.33 | 9.78 | 1.70 |
| 2X upsampling | 92.55 | 2.52 | 2.45 | 0.77 |
| 5X upsampling | 95.09 | 1.72 | 1.50 | 0.74 |

FIGS. 14A-16B present several general trends shared among all bridges. Concerning data set sizes, variance in network performance for both SP and FPR decreases with increasing data set size indicating that relationships between input signals and classification were more reliably established with increasing amounts of data. Models trained on smaller data sets struggled to learn the subtle patterns in the data, resulting in underperforming networks and significant variability in performance. Models trained on the data set with no upsampling had significantly larger variance than the models trained on larger data sets. This trend deviates with the more complex network architectures and indicates insufficient training likely caused by higher ratios of trainable parameters to training data set size. Regardless of data set size, complex network architectures in Table 6 failed to achieve the stability and performance compared with simpler architectures. For network architectures 1-4, which achieved more stable results with available training data sets, SP increased with increased training data while FPR decreased as expected.

With regard to bridge-specific performance, results from Bridge 1 again indicate slightly lower performance than the performances for Bridges 2-4. Bridge 1 experiences a 6.7% decrease and 2% increase in SP and FPR, respectively. This is attributed to construction activities occurring over significant portions of the monitoring effort; obvious nontrain, nonstrike signals were removed but additional construction activities may be present in the training and testing data set and appear as noisy train signals. These noisy signals negatively affect the training of Bridge 1 networks.

Across all network architectures, Architecture 2 achieved the best performance and balance between SP and FPR for all data set sizes as shown in Table 8. Architecture 2 was able to achieve, on average across all four bridges, 95.09% SP and 1.72% FPR when trained with the 5× upsampled data set.

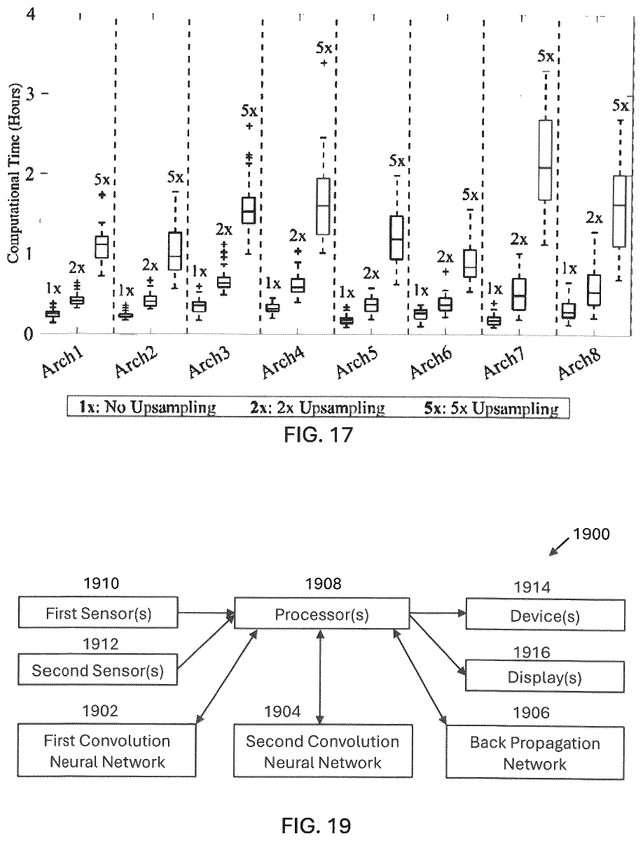

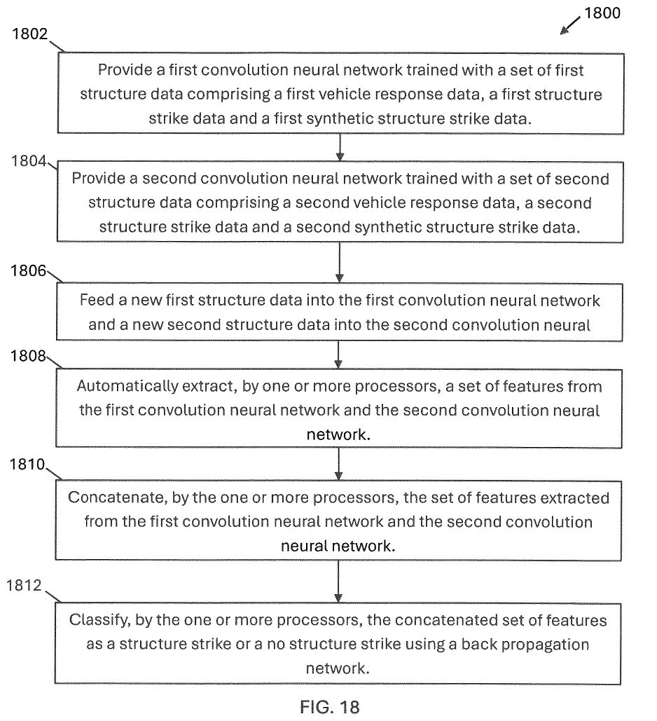

FIG. 18 provides the average computational times across the four bridges for all network architectures and data set sizes for reference. As expected, within a given architecture, training times increase with data set size; similarly, more complex networks generally take longer to train. Cross-referencing FIG. 17 with FIGS. 14A-16B provides a practical sense of required accuracy as a function of computational time. In this study, simpler architectures achieve the best accuracy and consume the least computational resources during training. The analyses were completed on the SMU ManeFrame 3 High Performance Super Computer with AMD EPYC 7763 processors and 25 GB RAM.

A PHD-CNN framework was developed for leveraging and fusing heterogeneous data streams to classify dynamic bridge response signatures with averages of 95% SP and 1.72% FPR using data from four in-service rail bridges collected under varying environmental conditions across 6 years. The PHD-CNN framework provides the rail management and operation community a tool with which to accurately identify strike events and respond promptly. Investigations concerning the effect of input data streams, data set size, and network architecture on network performance were also conducted. The inclusion and fusion of all available acceleration and tilt data streams in a PHD-CNN architecture yielded the highest overall performance across all four bridges. Networks trained on smaller data sets consume less training computational time, are more sensitive to changes in architecture complexity, and generally achieve lower SP and higher FPR compared to networks trained on larger data sets. The results from these investigations highlight the capabilities of the PHD-CNN framework to automatically extract and fuse diagnostic features from heterogeneous data streams without manual feature identification or calculation. The results of the data study described herein provide practical guidance for rail managers seeking to design and implement methodologies for bridge strike detection. In particular, FIGS. 14A-16B indicate the necessity of sufficient data for stable training and the trade-off between computational resources and performance. For the data available in this study, the simplest architectures investigated achieved the more efficient and best performance. With increased data availability, higher performances can be achieved at the cost of more powerful computational capabilities.

While the framework can help rail operators streamline the monitoring process of their structures, the following limitations must be considered:
1. The classification of any event signal requires instrumented sensors to be active continuously and events to be labeled properly. In Bridge 1, some events labeled as trains are actually construction events; such “noise” in the training data reduced the performance slightly compared to other bridges in the study.
2. Sensors in long-term data acquisition systems can drift over time and should be periodically calibrated or tared to ensure that data are not biased.
3. The current system only distinguishes strikes from passing trains. Ultimately, a strike severity rating would provide improved actionable information to railroad infrastructure managers. For example, a very light strike, may not result in any structural degradation and if properly identified and characterized as a light strike, an inspection might be deferred or scheduled in such a manner to minimize operations on the track or roadway below.

The system capabilities can be extended beyond strike detection toward strike severity rating, and ultimately, post strike bridge condition evaluation.

Some non-limiting embodiments of the present disclosure will now be described.

Now referring to FIG. 18, a flow chart of a method 1800 in accordance with one embodiment of the disclosure is shown. A first convolution neural network trained with a set of first structure data is provided in block 1802. The set of first structure data includes a first vehicle response data, a first structure strike data and a first synthetic structure strike data. A second convolution neural network trained with a set of second structure data is provided in block 1804. The vehicles can be trains, trucks, cars or any other vehicle that could potentially damage a structure (e.g., bridges, overpasses, underpasses, tunnels, etc.) by striking it. The set of second structure data includes a second vehicle response data, a second structure strike data and a second synthetic structure strike data. A new first structure data is fed into the first convolution neural network and a new second structure data is fed into the second convolution neural network in block 1806. A set of features from the first convolution neural network and the second convolution neural network are automatically extracted by one or more processors in block 1808. The set of features extracted from the first convolution neural network and the second convolution neural network are concatenated by the one or more processors in block 1810. The concatenated set of features are classified by the one or more processors as a structure strike or a no structure strike using a back propagation network in block 1812.

In one aspect, a structure strike severity is determined by one or more processors whenever an output of the back propagation network is the structure strike. For example, a class 1 strike severity could require immediate inspection, whereas a class 2 strike severity could require deferring inspection. In another aspect, the new first structure data is received from one or more first sensors and the new second structure data is received from one or more second sensors in near real time or real time. In another aspect: a message is automatically sent by the one or more processors to one or more devices communicably coupled to the one or more processors whenever an output of the back propagation network is the structure strike; or one or more displays communicably coupled to the one or more processors are automatically updated by the one or more processors to indicate the structure strike whenever the output of the back propagation network is the structure strike. In another aspect, the first structure data and the second structure data comprise heterogenous data streams. In another aspect, the first structure data and the second structure data are sampled at different rates. In another aspect, the first structure data comprises an acceleration data, a tilt data, a time series data, an image data, or an event report data; the second structure data comprises the acceleration data, the tilt data, the time series data, the image data, or the event report data; and the first structure data is not the same as the second structure data. In another aspect, the first or second convolution neural network is trained by: combining, by the one or more processors, a set of vehicle response data with a set of structure strike data for a set of structure; creating, by the one or more processors, a set of synthetic structure strike data by upsampling the set of structure strike data; for each structure, downsampling, by the one or more processors, the set of vehicle response data for the structure; for each structure, feeding, by the one or more processors, the set of downsampled vehicle response data for the structure, the structure strike data for the structure and the synthetic structure strike data for the structure into a convolution neural network cluster for the structure; generating, by the one or more processors, a set of randomly initialized convolution neural network clusters for each convolution neural network cluster; and training, by the one or more processors, each randomly initialized convolution neural network cluster using a random training subset of the downsampled vehicle response data, the structure strike data and the synthetic structure strike data. In another aspect: upsampling the set of structure strike data is performed until the set of structure strike data plus the set of synthetic structure strike data is approximately the same size as the set of vehicle response data for the set of structure; or downsampling the set of vehicle response data for the structure is performed until the set of downsampled vehicle response data for the structure is approximately equal to the set of structure strike data for the structure plus the set of synthetic structure strike data for the structure. In another aspect, each randomly initialized convolution neural network cluster is validated by the one or more processors using a random validation subset of the downsampled vehicle response data, the structure strike data and the synthetic structure strike data, wherein the random training subset is different the random validation subset. In another aspect, the set of vehicle response data and the set of structure strike data are standardized. In another aspect, the upsampling is performed at a multiplier of one, two, three, four, five or more.

Referring now to FIG. 19, a block diagram of a system 1900 in accordance with one embodiment of the disclosure is shown. The computerized system 1900 includes a first convolution neural network 1902, a second convolution neural network 1904, a back propagation network 1906, and one or more processors 1908. The first convolution neural network 1902, the second convolution neural network 1904, and the back propagation network 1906 can be hardware, software or a combination of both. Note that the system is not limited to the specific configuration shown in FIG. 19. Moreover, the system can be distributed across a network.

The first convolution neural network 1902 is trained with a set of first structure data comprising a first vehicle response data, a first structure strike data and a first structure synthetic strike data. The second convolution neural network 1904 is trained with a set of second structure data comprising a second vehicle response data, a second structure strike data and a second synthetic structure strike data. The vehicles can be trains, trucks, cars or any other vehicle that could potentially damage a structure (e.g., bridges, overpasses, underpasses, tunnels, etc.) by striking it. The one or more processors 1908 are configured to feed a new first structure data into the first convolution neural network 1902 and a new second structure data into the second convolution neural network 1904, automatically extract a set of features from the first convolution neural network 1902 and the second convolution neural network 1904, concatenate the set of features extracted from the first convolution neural network 1902 and the second convolution neural network 1904, and classify the concatenated set of features as a structure strike or a no structure strike using the back propagation network 1906.

In one aspect, the one or more processors are configured to determine a structure strike severity whenever an output of the back propagation network is the structure strike. For example, a class 1 strike severity could require immediate inspection, whereas a class 2 strike severity could require deferring inspection. In another aspect, the system includes: one or more first sensors 1910 communicably coupled to the one or more processors 1908; one or more second sensors 1912 communicably coupled to the one or more processors 1908; wherein the one or more processors 1908 receive a new first structure data from the one or more first sensors 1910 and a new second structure data from the one or more second sensors 1912 in near real time or real time. In another aspect, the system 1900 includes: one or more devices 1914 communicably coupled to the one or more processors 1908, wherein the one or more processors 1908 are configured to automatically send a message to the one or more devices 1914 whenever an output of the back propagation network is the structure strike; or one or more displays 1916 communicably coupled to the one or more processors 1908, wherein the one or more processors 1908 are configured to automatically update the one or more displays 1916 to indicate the structure strike whenever the output of the back propagation network is the structure strike.

In another aspect, the first structure data and the second structure data comprise heterogenous data streams. In another aspect, the first structure data and the second structure data are sampled at different rates. In another aspect: the first structure data comprises an acceleration data, a tilt data, a time series data, an image data, or an event report data; the second structure data comprises the acceleration data, the tilt data, the time series data, the image data, or the event report data; and the first structure data is not the same as the second structure data. In another aspect, the one or more processors train the first or second convolution neural network by: combining a set of vehicle response data with a set of structure strike data for a set of structures; creating a set of synthetic structure strike data by upsampling the set of structure strike data; for each structure, downsampling the set of vehicle response data for the structure; for each structure, feeding the set of downsampled vehicle response data for the structure, the structure strike data for the structure and the synthetic structure strike data for the structure into a convolution neural network cluster for the structure; generating a set of randomly initialized convolution neural network clusters for each convolution neural network cluster; and training each randomly initialized convolution neural network cluster using a random training subset of the downsampled vehicle response data, the structure strike data and the synthetic structure strike data. In another aspect: upsampling the set of structure strike data is performed until the set of structure strike data plus the set of synthetic structure strike data is approximately the same size as the set of vehicle response data for the set of structures; or downsampling the set of vehicle response data for the structure is performed until the set of downsampled vehicle response data for the structure is approximately equal to the set of structure strike data for the structure plus the set of synthetic structure strike data for the structure. In another aspect, the one or more processors validate each randomly initialized convolution neural network cluster using a random validation subset of the downsampled vehicle response data, the structure strike data and the synthetic structure strike data, wherein the random training subset is different the random validation subset. In another aspect, the one or more processors standardize the set of vehicle response data and the set of structure strike data. In another aspect, the upsampling is performed at a multiplier of one, two, three, four, five or more.

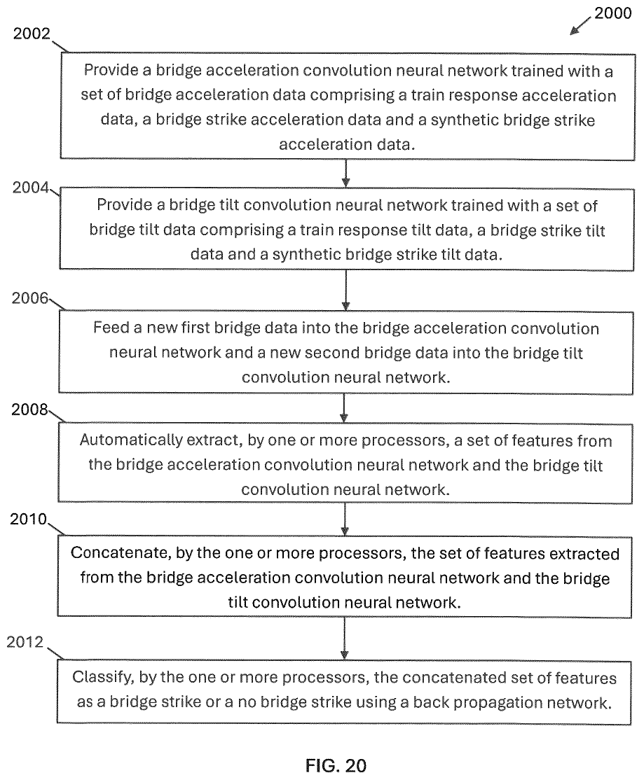

Now referring to FIG. 20, a flow chart of a method 2000 in accordance with another embodiment of the disclosure is shown. A bridge acceleration convolution neural network trained with a set of bridge acceleration data is provided in block 2002. The set of bridge acceleration data includes train response acceleration data, bridge strike acceleration data and synthetic bridge strike acceleration data. A bridge tilt convolution neural network trained with a set of bridge tilt data is provided in block 2004. The set of bridge tilt data includes a train response tilt data, bridge strike tilt data and synthetic bridge strike tilt data. New bridge acceleration data is fed into the bridge acceleration convolution neural network and new bridge tilt data is fed into the bridge tilt convolution neural network in block 2006. A set of features is automatically extracted, by one or more processors, from the bridge acceleration convolution neural network and the bridge tilt convolution neural network in block 2008. The set of features extracted from the bridge acceleration convolution neural network and the bridge tilt convolution neural network are concatenated by the one or more processors in block 2010. The concatenated set of features are classified by the one or more processors as a bridge strike or a no bridge strike using a back propagation network in block 2012.

In one aspect, a bridge strike severity is determined by one or more processors whenever an output of the back propagation network is the bridge strike. For example, a class 1 strike severity could require immediate inspection, whereas a class 2 strike severity could require deferring inspection. In another aspect, the new first bridge data is received from one or more first sensors and the new second bridge data is received from one or more second sensors in near real time or real time. In another aspect: a message is automatically sent by the one or more processors to one or more devices communicably coupled to the one or more processors whenever an output of the back propagation network is the bridge strike; or the one or more processors automatically update one or more displays communicably coupled to the one or more processors to indicate the bridge strike whenever the output of the back propagation network is the bridge strike. In another aspect, the new bridge acceleration data and the new bridge tilt data are heterogenous data streams. In another aspect: the new bridge acceleration data comprises at least two of a lateral acceleration data, a longitudinal acceleration data and a vertical acceleration data; and the new bridge tilt data comprises at least one of a rotation data about a longitudinal axis and a rotation data about a lateral axis. In another aspect: the bridge acceleration convolution neural network or the bridge tilt convolution neural network are further trained with a set of time series data, a set of image data, or a set of event report data; or a new time series data, new image data, or new event report data is fed into the bridge acceleration convolution neural network or the bridge tilt convolution neural network. In another aspect, the bridge acceleration convolution neural network or the bridge tilt convolution neural network are trained by: combining, by the one or more processors, a set of train response data with a set of bridge strike data for a set of bridges; creating, by the one or more processors, a set of synthetic bridge strike data by upsampling the set of bridge strike data; for each bridge, downsampling, by the one or more processors, the set of train response data for the bridge; for each bridge, feeding, by the one or more processors, the set of downsampled train response data for the bridge, the bridge strike data for the bridge and the synthetic bridge strike data for the bridge into a convolution neural network cluster for the bridge; generating, by the one or more processors, a set of randomly initialized convolution neural network clusters for each convolution neural network cluster; and training, by the one or more processors, each randomly initialized convolution neural network cluster using a random training subset of the downsampled train response data, the bridge strike data and the synthetic bridge strike data. In another aspect: upsampling the set of bridge strike data is performed until the set of bridge strike data plus the set of synthetic bridge strike data is approximately the same size as the set of train response data for the set of bridges; or downsampling the set of train response data for the bridge is performed until the set of downsampled train response data for the bridge is approximately equal to the set of bridge strike data for the bridge plus the set of synthetic bridge strike data for the bridge. In another aspect, each randomly initialized convolution neural network cluster is validated by the one or more processors using a random validation subset of the downsampled train response data, the bridge strike data and the synthetic bridge strike data, wherein the random training subset is different the random validation subset. In another aspect, the set of train response data and the set of bridge strike data are standardized. In another aspect, the upsampling is performed at a multiplier of one, two, three, four, five or more.

Referring now back to FIG. 19, a block diagram of a system 1900 in accordance with another embodiment of the disclosure is shown. In this embodiment, the first convolution neural network 1902 is a bridge acceleration convolution neural network, and the second convolution neural network 1904 is a bridge tilt convolution neural network. As a result, the system 1900 in this embodiment includes a bridge acceleration convolution neural network 1902, a bridge acceleration convolution neural network 1904, a back propagation network 1906, and one or more processors 1908. The bridge acceleration convolution neural network 1902, the bridge acceleration convolution neural network 1904, and the back propagation network 1906 can be hardware, software or a combination of both. Note that the system is not limited to the specific configuration shown in FIG. 19. Moreover, the system can be distributed across a network.

The bridge acceleration convolution neural network 1902 is trained with a set of bridge acceleration data comprising train response acceleration data, bridge strike acceleration data and synthetic strike acceleration data. The bridge tilt convolution neural network 1904 is trained with a set of bridge tilt data comprising a train response tilt data, bridge strike tilt data and synthetic strike tilt data. The one or more processors 1908 are configured to feed new bridge acceleration data into the bridge acceleration convolution neural network 1902 and new bridge tilt data into the bridge tilt convolution neural network 1904, automatically extract a set of features from the bridge acceleration convolution neural network 1902 and the bridge tilt convolution neural network 1904, concatenate the set of features extracted from the bridge acceleration convolution neural network 1902 and the bridge tilt convolution neural network 1904, and classify the concatenated set of features as a bridge strike or a no bridge strike using a back propagation network 1906.

In one aspect, the one or more processors 1908 are configured to determine a bridge strike severity whenever an output of the back propagation network is a bridge strike. For example, a class 1 strike severity could require immediate inspection, whereas a class 2 strike severity could require deferring inspection. In another aspect, the system includes: one or more first sensors 1910 communicably coupled to the one or more processors; one or more second sensors 1912 communicably coupled to the one or more processors; wherein the one or more processors 1908 receive a new first bridge data from the one or more first sensors 1910 and a new second bridge data from the one or more second sensors 1912 in near real time or real time. In another aspect, the system 1900 includes: one or more devices 1914 communicably coupled to the one or more processors 1908, wherein the one or more processors 1908 are configured to automatically send a message to the one or more devices 1914 whenever an output of the back propagation network is the bridge strike; or one or more displays 1916 communicably coupled to the one or more processors 1908, wherein the one or more processors 1908 are configured to automatically update the one or more displays 1916 to indicate the bridge strike whenever the output of the back propagation network 1906 is the bridge strike.

In another aspect, the new bridge acceleration data and the new bridge tilt data are heterogenous data streams. In another aspect: the new bridge acceleration data comprises at least two of a lateral acceleration data, a longitudinal acceleration data and a vertical acceleration data; and the new bridge tilt data comprises at least one of a rotation data about a longitudinal axis and a rotation data about a lateral axis. In another aspect, the bridge acceleration convolution neural network or the bridge tilt convolution neural network are further trained with a set of time series data, a set of image data, or a set of event report data; or a new time series data, new image data, or new event report data is fed into the bridge acceleration convolution neural network or the bridge tilt convolution neural network. In another aspect, the bridge acceleration convolution neural network or the bridge tilt convolution neural network are trained by: combining, by the one or more processors, a set of train response data with a set of bridge strike data for a set of bridges; creating, by the one or more processors, a set of synthetic bridge strike data by upsampling the set of bridge strike data; for each bridge, downsampling, by the one or more processors, the set of train response data for the bridge; for each bridge, feeding, by the one or more processors, the set of downsampled train response data for the bridge, the bridge strike data for the bridge and the synthetic bridge strike data for the bridge into a convolution neural network cluster for the bridge; generating, by the one or more processors, a set of randomly initialized convolution neural network clusters for each convolution neural network cluster; and training, by the one or more processors, each randomly initialized convolution neural network cluster using a random training subset of the downsampled train response data, the bridge strike data and the synthetic bridge strike data. In another aspect: upsampling the set of bridge strike data is performed until the set of bridge strike data plus the set of synthetic bridge strike data is approximately the same size as the set of train response data for the set of bridges; or downsampling the set of train response data for the bridge is performed until the set of downsampled train response data for the bridge is approximately equal to the set of bridge strike data for the bridge plus the set of synthetic bridge strike data for the bridge. In another aspect, each randomly initialized convolution neural network cluster is validated by the one or more processors using a random validation subset of the downsampled train response data, the bridge strike data and the synthetic bridge strike data, wherein the random training subset is different the random validation subset. In another aspect, further comprising standardizing the set of train response data and the set of bridge strike data. In another aspect, the upsampling is performed at a multiplier of one, two, three, four, five or more.

The foregoing methods and systems can be implemented as one or more non-transitory computer-readable media that stores instructions that when executed cause a computing device or system to perform the stated operations.

It is contemplated that any aspects of the disclosure discussed in this specification can be implemented with respect to any method, apparatus or system of the disclosure, and vice versa.

It will be understood that particular aspects described herein are shown by way of illustration and not as limitations of the disclosure. The principal features of this disclosure can be employed in various aspects without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In aspects of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the disclosure(s) set out in any claims that may issue from this disclosure. Specifically, and by way of example, although the headings refer to a “Field of Invention,” such claims should not be limited by the language under this heading to describe the so-called technical field. Further, a description of technology in the “Background of the Invention” section is not to be construed as an admission that technology is prior art to any disclosure(s) in this disclosure. Neither is the “Summary” to be considered a characterization of the disclosure(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure but should not be constrained by the headings set forth herein.

All of the compositions and/or methods disclosed and claimed herein can be made and executed without undue experimentation in light of the present disclosure. While the compositions and methods of this disclosure have been described in terms of preferred aspects, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

Abdeljaber, O., Avci, O., Kiranyaz, S., Gabbouj, M., & Inman, D. J. (2017). Real-time vibration-based structural damage detection using one-dimensional convolutional neural networks. Journal of Sound and Vibration, 338, 154-170.
Adeli, H. (2001). Neural networks in civil engineering: 1989-2000. Computer-Aided Civil and Infrastructure Engineering, 16, 126-142.
Adeli, H., & Kumar, S. (1995). Concurrent structural optimization on a massively parallel supercomputer. Journal of Structural Engineering, 121(11), 1588-1597.
Association of American Railroads. (2023). Freight rail bridge safety. Website aar.org/issue/bridge-safety.
Avci, O., Abdeljaber, O., Kiranyaz, S., & Inman, D. (2017). Structural damage detection in real time: Implementation of 1D convolutional neural networks for SHM applications. In C. Niezrecki (Ed.), Structural health monitoring & damage detection: Proceedings of the 35th IMAC, a conference and exposition on structural dynamics 2017 (Vol. 7, pp. 49-54). Springer International Publishing.
Avci, O., Abdeljaber, O., Kiranyaz, S., Hussein, M., & Inman, D. J. (2018). Wireless and real-time structural damage detection: A novel decentralized method for wireless sensor networks. Journal of Sound and Vibration, 424, 158-172.
Beck, J. L., Au, S. K., & Vanik, M. W. (2001). Monitoring structural health using a probabilistic measure. Computer-Aided Civil and Infrastructure Engineering, 16(1), 1-11.
Berrar, D. (2018). Cross-validation. Encyclopedia of Bioinformatics and Computational Biology, 1, 542-545.
Byrne, A. (2009). Railway bridges in Ireland & bridge strike trends. Railway Safety Commission, Dublin, Ireland.
Cha, Y. J., Choi, W., & Büyüköztürk, O. (2017). Deep learning-based crack damage detection using convolutional neural networks. Computer-Aided Civil and Infrastructure Engineering, 32(5), 361-378.
Chawla, N. V., Bowyer, K. W., Hall, L. O., & Kegelmeyer, W. P. (2002). SMOTE: Synthetic minority over-sampling technique. Journal of Artificial Intelligence Research, 16, 321-357.
de Geus, A. R., Backes, A. R., & Souza, J. R. (2020). Variability evaluation of CNNs using cross-validation on viruses images. In K. Bouatouch, A. A. de Sousa, M. Chessa, A. Paljic, A. Kerren, C. Hurter, G. M. Farinella, P. Radeva, & J. Braz (Eds.), VISIGRAPP (4: VISAPP) (pp. 626-632). Scite Press.
Federal Railroad Administration (FRA). (2018). Bridge safety standards compliance manual.
Fu, Y., Zhu, Y., Hoang, T., Mechitov, K., & Spencer Jr, B. F. (2022). xImpact: Intelligent wireless system for cost-effective rapid condition assessment of bridges under impacts. Sensors, 22(15), 5701.
Ge, C., Gu, I. Y. H., Jakola, A. S., & Yang, J. (2018). Deep learning and multi-sensor fusion for glioma classification using multistream 2D convolutional networks. In J. Patton (Ed.), 2018 40th annual international conference of the IEEE engineering in medicine and biology society (EMBC) (pp. 5894-5897). IEEE.
Gopalakrishnan, K., Gholami, H., Vidyadharan, A., Choudhary, A., & Agrawal, A. (2018). Crack damage detection in unmanned aerial vehicle images of civil infrastructure using pre-trained deep learning model. International Journal of Traffic and Transportation Engineering, 8(1), 1-14.
Götz, T. I., Göb, S., Sawant, S., Erick, X. F., Wittenberg, T., Schmidkonz, C., Tomé, A. M., Lang, E. W., & Ramming, A. (2022). Number of necessary training examples for neural networks with different number of trainable parameters. Journal of Pathology Informatics, 13, 100114.
Graf, W., Freitag, S., Sickert, J. U., & Kaliske, M. (2012). Structural analysis with fuzzy data and neural network based material description. Computer-Aided Civil and Infrastructure Engineering, 27(9), 640-654.
Guzman-Acevedo, G. M., Vazquez-Becerra, G. E., Millan-Almaraz, J. R., Rodriguez-Lozoya, H. E., Reyes-Salazar, A., Gaxiola-Camacho, J. R., & Martinez-Felix, C. A. (2019). GPS, accelerometer, and smartphone fused smart sensor for SHM on real-scale bridges. Advances in Civil Engineering, 2019, 15.
Hagan, H. T., Demuth, H. B., & Beale, M. (1996). Neural network design. PWS Publishing Company.
Hanker, M, Hu, M. Y., & Hung, M. S. (1996). Effect of data standardization on neural network training. Omega, 24(4), 385-397.
Hao, W., Yizhou, W., Yaqin, L., & Zhili, S. (2020). The role of activation function in CNN. In C. Ceballos (Ed.), 2020 2nd international conference on information technology and computer application (ITCA) (pp. 429-432). IEEE.
Haykin, S. (1994). Neural networks: A comprehensive foundation. Macmillan College Publishing Company.
Israel, I. M., Israel, S. A., & Irvine, J. M. (2021). Factors influencing CNN performance. In IEEE applied imagery pattern recognition workshop (AIPR) (pp. 1-4). Washington, DC, USA: IEEE.
Jiang, X., & Adeli, H. (2005). Dynamic wavelet neural network for nonlinear identification of highrise buildings. Computer-Aided Civil and Infrastructure Engineering, 20(5), 316-330.
Joy, R., Jones, M. C., Otter, D., & Maal, L. (2013). Characterization of railroad bridge service interruptions (No. DOT/FRA/ORD-13/05). United States Federal Railroad Administration. Office of Research and Development.
Kiranyaz, S., Ince, T., & Gabbouj, M. (2016). Real-time patient specific ECG classification by 1-D convolutional neural networks. IEEE Transactions on Biomedical Engineering, 63, 664-675.
Kołakowski, P., Szela̧żek, J., Sekuła, K., Świercz, A., Mizerski, K., & Gutkiewicz, P. (2011). Structural health monitoring of a railway truss bridge using vibration-based and ultrasonic methods. Smart Materials and Structures, 20(3), 035016.
Krizhevsky, A., Sutskever, I., & Hinton, G. E. (2012). Imagenet classification with deep convolutional neural networks. Advances in Neural Information Processing Systems, 25, 1097-1105.
Lam, H. F., Yuen, K. V., & Beck, J. L. (2006). Structural health monitoring via measured Ritz vectors utilizing artificial neural networks. Computer-Aided Civil and Infrastructure Engineering, 21(4), 232-241.
Lawal, O., Shajihan, S. A. V., Mechitov, K., & Spencer Jr, B. F. (2023). An event-classification neural network approach for rapid railroad bridge impact detection. Sensors, 23(6), 3330.
LeCun, Y., Bottou, L., Bengio, Y., &Haffner, P. (1998). Gradient-based learning applied to document recognition. Proceedings of the IEEE, 86(11), 2278-2324.
Luo, C., Li, X., Wang, L., He, J., Li, D., & Zhou, J. (2018). How does the data set affect CNN-based image classification performance? In W. Tu, L. Wang, C. Ji, N. Chen, Q. Sun, X. Song, & X. Wang (Eds.), International conference on systems and informatics (ICSAI) (pp. 361-366), Nanjing, China: IEEE.
Moreu, F., Kim, R. E., & Spencer Jr, B. F. (2017). Railroad bridge monitoring using wireless smart sensors. Structural Control and Health Monitoring, 24(2), e1863.
Network Rail. (2017). The risk of bridge strikes. website networkrail.co.uk/running-the-railway/looking-after-therailway/
Nguyen, B., &Brilakis, I. (2016). Understanding the problem of bridge and tunnel strikes caused by over-height vehicles. Transportation Research Procedia, 14, 3915-3924.
Nti, I. K., Nyarko-Boateng, O., & Aning, J. (2021). Performance of machine learning algorithms with different K values in K-fold cross-validation. International Journal of Information Technology and Computer Science, 13(6), 61-71.
Omidalizarandi, M., Herrmann, R., Kargoll, B., Marx, S., Paffenholz, J. A., & Neumann, I. (2020). A validated robust and automatic procedure for vibration analysis of bridge structures using MEMS accelerometers. Journal of Applied Geodesy, 14(3), 327-354.
Park, H. S., & Adeli, H. (1997). Distributed neural dynamics algorithms for optimization of large steel structures, Journal of Structural Engineering, 123(7), 880-888.
Otter, D., Unsworth, J. F., & Carter Jr, J. N. (2017). A railroad perspective on bridge measurement and monitoring systems. In J. G. Soules (Ed.), Structures congress 2017 (pp. 302-313). ASCE.
Ozdagli, A. I., Moreu, F., Xu, D., & Wang, T. (2020). Experimental analysis on effectiveness of crash beams for impact attenuation of overheight vehicle collisions on railroad bridges. Journal of Bridge Engineering, 25(1), 04019133.
Qiao, L., Esmaeily, A., & Melhem, H. G. (2012). Signal pattern recognition for damage diagnosis in structures. Computer-Aided Civil and Infrastructure Engineering, 27(9), 699-710.
Rosenblatt, F. (1958). The perceptron: A probabilistic model for information storage and organization of the brain. Psychological Review, 65, 386-408.
Shaikhina, T., & Khovanova, N. A. (2017). Handling limited datasets with neural networks in medical applications: A small-data approach. Artificial Intelligence in Medicine, 75, 51-63.
Shanker, M., Hu, M. Y., & Hung, M. S. (1996). Effect of data standardization on neural network training. Omega, 24(4), 385-397.
Sitton, J. D., Story, B. A., &Zeinali, Y. (2017a). Bridge impact detection and classification using artificial neural networks. In F.-K. Chang & F. Kopsaftopoulos (Eds.), Proceedings of the International workshop on structural health monitoring (IWSHM) (pp. 12-14), Palo Alto, CA: Research Gate.
Sitton, J. D., Zeinali, Y., & Story, B. A. (2017b). Rapid soil classification using artificial neural networks for use in constructing compressed earth blocks. Construction and Building Materials, 138, 214-221.
Sitton, J. D., Zeinali, Y., & Story, B. A. (2019). Design and field implementation of an impact detection system using committees of neural networks. Expert Systems with Applications, 120, 185-196.
Story, B. A., & Fry, G. T. (2014a). Methodology for designing diagnostic data streams for use in a structural impairment detection system. Journal of Bridge Engineering, 19(4), 04013020.
Story, B. A., & Fry, G. T. (2014b). A structural impairment detection system using competitive arrays of artificial neural networks. Computer-Aided Civil and Infrastructure Engineering, 145, 868-875.
Teng, S., Chen, X., Chen, G., Cheng, L., & Bassir, D. (2022). Structural damage detection based on convolutional neural networks and population of bridges. Measurement, 202, 111747.
Tu, Z., Xie, W., Qin, Q., Poppe, R., Veltkamp, R. C., Li, B., & Yuan, J. (2018). Multi-stream CNN: Learning representations based on human-related regions for action recognition. Pattern Recognition, 79, 32-43.
Vardanega, P. J., Webb, G. T., Fidler, P. R. A., Huseynov, F., Kariyawasam, K. K. G. K. D., & Middleton, C. R. (2022). Bridge monitoring. In A. Pipinato (Ed.), Innovative bridge design handbook (pp. 893-932). Butterworth-Heinemann.
Yang, M. (2015). An integrated real-time health monitoring and impact collision detection system for bridges in cold remote regions (No. MPC 15-282). Mountain Plains Consortium.
Ying, X. (2019). An overview of overfitting and its solutions. Journal of Physics: Conference Series, 1168, 022022.
Yuen, K. V., & Katafygiotis, L. S. (2006). Substructure identification and health monitoring using noisy response measurements only. Computer-Aided Civil and Infrastructure Engineering, 21(4), 280-291.
Zhang, X., Rajan, D., & Story, B. (2019). Concrete crack detection using context-aware deep semantic segmentation network. Computer-Aided Civil and Infrastructure Engineering, 34(11), 951-971.

What is claimed is:

1. A computer-implemented method for detecting structure strikes by vehicles, the method comprising:
providing a first convolution neural network trained with a set of first structure data comprising a first vehicle response data, a first structure strike data and a first synthetic structure strike data;
providing a second convolution neural network trained with a set of second structure data comprising a second vehicle response data, a second structure strike data and a second synthetic structure strike data;
feeding a new first structure data into the first convolution neural network and a new second structure data into the second convolution neural network;
automatically extracting, by one or more processors, a set of features from the first convolution neural network and the second convolution neural network;
concatenating, by the one or more processors, the set of features extracted from the first convolution neural network and the second convolution neural network; and
classifying, by the one or more processors, the concatenated set of features as a structure strike or a no structure strike using a back propagation network.

2. The method of claim 1, further comprising determining, by one or more processors, a structure strike severity whenever an output of the back propagation network is the structure strike.

3. The method of claim 1, further comprising receiving a new first structure data from one or more first sensors and a new second structure data from one or more second sensors in near real time or real time.

4. The method of claim 1, further comprising:
automatically sending, by the one or more processors, a message to one or more devices communicably coupled to the one or more processors whenever an output of the back propagation network is the structure strike; or
automatically updating, by the one or more processors, one or more displays communicably coupled to the one or more processors to indicate the structure strike whenever the output of the back propagation network is the structure strike.

5. The method of claim 1, wherein the first structure data and the structure data comprise heterogenous data streams.

6. The method of claim 1, wherein the first structure data and the second structure data are sampled at different rates.

7. The method of claim 1, wherein:
the first structure data comprises an acceleration data, a tilt data, a time series data, an image data, or an event report data;
the second structure data comprises the acceleration data, the tilt data, the time series data, the image data, or the event report data; and
the first structure data is not the same as the second structure data.

8. The method of claim 1, further comprising training the first or second convolution neural network by:
combining, by the one or more processors, a set of vehicle response data with a set of structure strike data for a set of structures;
creating, by the one or more processors, a set of synthetic structure strike data by upsampling the set of structure strike data;
for each structure, downsampling, by the one or more processors, the set of vehicle response data for the structure;
for each structure, feeding, by the one or more processors, the set of downsampled vehicle response data for the structure, the structure strike data for the structure and the synthetic structure strike data for the structure into a convolution neural network cluster for the structure;
generating, by the one or more processors, a set of randomly initialized convolution neural network clusters for each convolution neural network cluster; and
training, by the one or more processors, each randomly initialized convolution neural network cluster using a random training subset of the downsampled vehicle response data, the structure strike data and the synthetic structure strike data.

9. The method of claim 8, wherein:
upsampling the set of structure strike data is performed until the set of structure strike data plus the set of synthetic structure strike data is approximately the same size as the set of vehicle response data for the set of structures; or
downsampling the set of vehicle response data for the structure is performed until the set of downsampled vehicle response data for the structure is approximately equal to the set of structure strike data for the structure plus the set of synthetic structure strike data for the structure.

10. The method of claim 8, further comprising validating, by the one or more processors, each randomly initialized convolution neural network cluster using a random validation subset of the downsampled vehicle response data, the structure strike data and the synthetic structure strike data, wherein the random training subset is different the random validation subset.

11. The method of claim 8, further comprising standardizing the set of vehicle response data and the set of structure strike data.

12. The method of claim 8, wherein the upsampling is performed at a multiplier of one, two, three, four, five or more.

13. A computerized system for detecting structure strikes by vehicles comprising:
a first convolution neural network trained with a set of first structure data comprising a first vehicle response data, a first structure strike data and a first synthetic structure strike data;
a second convolution neural network trained with a set of second structure data comprising a second vehicle response data, a second structure strike data and a second synthetic structure strike data; and
one or more processors configured to feed a new first structure data into the first convolution neural network and a new second structure data into the second convolution neural network, automatically extract a set of features from the first convolution neural network and the second convolution neural network, concatenate the set of features extracted from the first convolution neural network and the second convolution neural network, and classify the concatenated set of features as a structure strike or a no structure strike using a back propagation network.

14. The computerized system of claim 13, wherein the one or more processors are configured to determine a structure strike severity whenever an output of the back propagation network is the structure strike.

15. The computerized system of claim 13, further comprising:
one or more first sensors communicably coupled to the one or more processors;
one or more second sensors communicably coupled to the one or more processors; and
wherein the one or more processors receive a new first structure data from the one or more first sensors and a new second structure data from the one or more second sensors in near real time or real time.

16. The computerized system of claim 13, further comprising:
one or more devices communicably coupled to the one or more processors, wherein the one or more processors are configured to automatically send a message to the one or more devices whenever an output of the back propagation network is the structure strike; or
one or more displays communicably coupled to the one or more processors, wherein the one or more processors are configured to automatically update the one or more displays to indicate the structure strike whenever the output of the back propagation network is the structure strike.

17. The computerized system of claim 13, wherein the first structure data and the second structure data comprise heterogenous data streams.

18. The computerized system of claim 13, wherein the first structure data and the second structure data are sampled at different rates.

19. The computerized system of claim 13, wherein:
the first structure data comprises an acceleration data, a tilt data, a time series data, an image data, or an event report data;
the second structure data comprises the acceleration data, the tilt data, the time series data, the image data, or the event report data; and
the first structure data is not the same as the second structure data.

20. The computerized system of claim 13, wherein the one or more processors train the first or second convolution neural network by:
combining a set of vehicle response data with a set of structure strike data for a set of structure;
creating a set of synthetic structure strike data by upsampling the set of structure strike data;
for each structure, downsampling the set of vehicle response data for the structure;
for each structure, feeding the set of downsampled vehicle response data for the structure, the structure strike data for the structure and the synthetic structure strike data for the structure into a convolution neural network cluster for the structure;
generating a set of randomly initialized convolution neural network clusters for each convolution neural network cluster; and
training each randomly initialized convolution neural network cluster using a random training subset of the downsampled vehicle response data, the structure strike data and the synthetic structure strike data.

21. The computerized system of claim 20, wherein:
upsampling the set of structure strike data is performed until the set of structure strike data plus the set of synthetic structure strike data is approximately the same size as the set of vehicle response data for the set of structure; or
downsampling the set of vehicle response data for the structure is performed until the set of downsampled vehicle response data for the structure is approximately equal to the set of structure strike data for the structure plus the set of synthetic structure strike data for the structure.

22. The computerized system of claim 20, wherein the one or more processors validate each randomly initialized convolution neural network cluster using a random validation subset of the downsampled vehicle response data, the structure strike data and the synthetic structure strike data, wherein the random training subset is different the random validation subset.

23. The computerized system of claim 20, wherein the one or more processors standardize the set of vehicle response data and the set of structure strike data.

24. The computerized system of claim 20, wherein the upsampling is performed at a multiplier of one, two, three, four, five or more.

25. A computer-implemented method for detecting bridge strikes, the method comprising:
providing a bridge acceleration convolution neural network trained with a set of bridge acceleration data comprising train response acceleration data, bridge strike acceleration data and synthetic bridge strike acceleration data;
providing a bridge tilt convolution neural network trained with a set of bridge tilt data comprising a train response tilt data, bridge strike tilt data and synthetic bridge strike tilt data;
feeding new bridge acceleration data into the bridge acceleration convolution neural network and new bridge tilt data into the bridge tilt convolution neural network;
automatically extracting, by one or more processors, a set of features from the bridge acceleration convolution neural network and the bridge tilt convolution neural network;
concatenating, by the one or more processors, the set of features extracted from the bridge acceleration convolution neural network and the bridge tilt convolution neural network; and
classifying, by the one or more processors, the concatenated set of features as a bridge strike or a no bridge strike using a back propagation network.

26. The method of claim 25, further comprising determining, by one or more processors, a bridge strike severity whenever an output of the back propagation network is the bridge strike.

27. The method of claim 25, further comprising receiving a new first bridge data from one or more first sensors and a new second bridge data from one or more second sensors in near real time or real time.

28. The method of claim 25, further comprising:
automatically sending, by the one or more processors, a message to one or more devices communicably coupled to the one or more processors whenever an output of the back propagation network is the bridge strike; or
automatically updating, by the one or more processors, one or more displays communicably coupled to the one or more processors to indicate the bridge strike whenever the output of the back propagation network is the bridge strike.

29. The method of claim 25, wherein the new bridge acceleration data and the new bridge tilt data are heterogenous data streams.

30. The method of claim 25, wherein:
the new bridge acceleration data comprises at least two of a lateral acceleration data, a longitudinal acceleration data and a vertical acceleration data; and
the new bridge tilt data comprises at least one of a rotation data about a longitudinal axis and a rotation data about a lateral axis.

31. The method of claim 25, wherein:
the bridge acceleration convolution neural network or the bridge tilt convolution neural network are further trained with a set of time series data, a set of image data, or a set of event report data; or
a new time series data, new image data, or new event report data is fed into the bridge acceleration convolution neural network or the bridge tilt convolution neural network.

32. The method of claim 25, further comprising training the bridge acceleration convolution neural network or the bridge tilt convolution neural network by:
combining, by the one or more processors, a set of train response data with a set of bridge strike data for a set of bridges;
creating, by the one or more processors, a set of synthetic bridge strike data by upsampling the set of bridge strike data;
for each bridge, downsampling, by the one or more processors, the set of train response data for the bridge;
for each bridge, feeding, by the one or more processors, the set of downsampled train response data for the bridge, the bridge strike data for the bridge and the synthetic bridge strike data for the bridge into a convolution neural network cluster for the bridge;
generating, by the one or more processors, a set of randomly initialized convolution neural network clusters for each convolution neural network cluster; and
training, by the one or more processors, each randomly initialized convolution neural network cluster using a random training subset of the downsampled train response data, the bridge strike data and the synthetic bridge strike data.

33. The method of claim 32, wherein:
upsampling the set of bridge strike data is performed until the set of bridge strike data plus the set of synthetic bridge strike data is approximately the same size as the set of train response data for the set of bridges; or
downsampling the set of train response data for the bridge is performed until the set of downsampled train response data for the bridge is approximately equal to the set of bridge strike data for the bridge plus the set of synthetic bridge strike data for the bridge.

34. The method of claim 32, further comprising validating, by the one or more processors, each randomly initialized convolution neural network cluster using a random validation subset of the downsampled train response data, the bridge strike data and the synthetic bridge strike data, wherein the random training subset is different the random validation subset.

35. The method of claim 32, further comprising standardizing the set of train response data and the set of bridge strike data.

36. The method of claim 32, wherein the upsampling is performed at a multiplier of one, two, three, four, five or more.

37. A computerized system for detecting bridge strikes comprising:
a bridge acceleration convolution neural network trained with a set of bridge acceleration data comprising train response acceleration data, bridge strike acceleration data and synthetic bridge strike acceleration data;
a bridge tilt convolution neural network trained with a set of bridge tilt data comprising a train response tilt data, bridge strike tilt data and synthetic bridge strike tilt data; and
one or more processors configured to feed new bridge acceleration data into the bridge acceleration convolution neural network and new bridge tilt data into the bridge tilt convolution neural network, automatically extract a set of features from the bridge acceleration convolution neural network and the bridge tilt convolution neural network, concatenate the set of features extracted from the bridge acceleration convolution neural network and the bridge tilt convolution neural network, and classify the concatenated set of features as a bridge strike or a no bridge strike using a back propagation network.

38. The computerized system of claim 37, wherein the one or more processors are configured to determine a bridge strike severity whenever an output of the back propagation network is a bridge strike.

39. The computerized system of claim 37, further comprising:
one or more first sensors communicably coupled to the one or more processors;
one or more second sensors communicably coupled to the one or more processors; and
wherein the one or more processors receive a new first bridge data from the one or more first sensors and the a second bridge data from the one or more second sensors in near real time or real time.

40. The computerized system of claim 37, further comprising:
one or more devices communicably coupled to the one or more processors, wherein the one or more processors are configured to automatically send a message to the one or more devices whenever an output of the back propagation network is the bridge strike; or
one or more displays communicably coupled to the one or more processors, wherein the one or more processors are configured to automatically update the one or more displays to indicate the bridge strike whenever the output of the back propagation network is the bridge strike.

41. The computerized system of claim 37, wherein the new bridge acceleration data and the new bridge tilt data are heterogenous data streams.

42. The computerized system of claim 37, wherein:
the new bridge acceleration data comprises at least two of a lateral acceleration data, a longitudinal acceleration data and a vertical acceleration data; and
the new bridge tilt data comprises at least one of a rotation data about a longitudinal axis and a rotation data about a lateral axis.

43. The computerized system of claim 37, wherein:
the bridge acceleration convolution neural network or the bridge tilt convolution neural network are further trained with a set of time series data, a set of image data, or a set of event report data; or
a new time series data, new image data, or new event report data is fed into the bridge acceleration convolution neural network or the bridge tilt convolution neural network.

44. The computerized system of claim 37, further comprising training the bridge acceleration convolution neural network or the bridge tilt convolution neural network by:
combining, by the one or more processors, a set of train response data with a set of bridge strike data for a set of bridges;
creating, by the one or more processors, a set of synthetic bridge strike data by upsampling the set of bridge strike data;
for each bridge, downsampling, by the one or more processors, the set of train response data for the bridge;
for each bridge, feeding, by the one or more processors, the set of downsampled train response data for the bridge, the bridge strike data for the bridge and the synthetic bridge strike data for the bridge into a convolution neural network cluster for the bridge;
generating, by the one or more processors, a set of randomly initialized convolution neural network clusters for each convolution neural network cluster; and
training, by the one or more processors, each randomly initialized convolution neural network cluster using a random training subset of the downsampled train response data, the bridge strike data and the synthetic bridge strike data.

45. The computerized system of claim 44, wherein:
upsampling the set of bridge strike data is performed until the set of bridge strike data plus the set of synthetic bridge strike data is approximately the same size as the set of train response data for the set of bridges; or
downsampling the set of train response data for the bridge is performed until the set of downsampled train response data for the bridge is approximately equal to the set of bridge strike data for the bridge plus the set of synthetic bridge strike data for the bridge.

46. The computerized system of claim 44, further comprising validating, by the one or more processors, each randomly initialized convolution neural network cluster using a random validation subset of the downsampled train response data, the bridge strike data and the synthetic bridge strike data, wherein the random training subset is different the random validation subset.

47. The computerized system of claim 44, further comprising standardizing the set of train response data and the set of bridge strike data.

48. The computerized system of claim 44, wherein the upsampling is performed at a multiplier of one, two, three, four, five or more.
